(19) United States
(12) Patent Application Publication
(10) Pub. No.: US 2011/0176029 A1
(43) Pub. Date: Jul. 21, 2011

(54) Multispectral and Colorimetric Imaging System

(76) Inventors: Kenneth Wayne Boydston, Ojai, CA (US); Brian D. Amrine, Goleta, CA (US); William A. Christens-Barry, Ellicot City, MD (US); Richard Michael Colvin, Goleta, CA (US)

(21) Appl. No.: 13/007,623

(22) Filed: Jan. 15, 2011

Related U.S. Application Data
(60) Provisional application No. 61/336,042, filed on Jan. 15, 2010.

(51) Int. Cl. H04N 9/73; G06K 9/00

(52) U.S. Cl. 348/223.1; 382/162; 348/E09.051

(57) ABSTRACT

Methods and apparatus enable capture of images of a scene in response to various spectral distributions of light, as well as processing of the captured images to adjust them and, in the case of particular sets of spectral distributions, to derive images accurately representing the colors of the scene.

### CROSS-REFERENCE TO RELATED APPLICATIONS

This application claims the benefit of U.S. Provisional Patent Application No. 61/336,042 filed Jan. 15, 2010, Filed by Kenneth Wayne Boydston, and titled “Multi-spectral imaging and Color Reproduction System” the subject matter of which is also incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Images of objects carry in them information about the objects that the image records. Information about shapes, sizes, colors, surfaces, composition, and constituents, among a wide array of other information both direct and inferred may be recorded in the images.

An image of an object, (usually captured through a lens onto a recording medium), implies that light energy (visible or not) has been emitted by, transmitted through, or reflected from the object, and it is this light energy that, in conjunction with the recording media and its associated infrastructure (often including image forming optics and electronic or chemical processes) creates the image. The image may be saved to or stored on a medium from which, particularly in the case of a digital image, it is decoupled in such a way that the storage medium does not influence the image information recorded by the recording device.

The term “light” is commonly used to describe that portion of the electromagnetic spectrum that can be perceived by human vision. This term is often understood to encompass regions of the electromagnetic spectrum flanking the range of human visual sensitivity (typically regarded as approximately 400 nm to 720 nm) having somewhat longer wavelengths (so called “infrared” light) and somewhat shorter wavelengths (so called “ultraviolet” light). Here, the term light is used to refer to the broader range of electromagnetic wavelengths that can be sensed by visual or artificial means through the use of detectors of the kinds used in digital photography or image recording.

An image of an object is the result of light that impinges on the object, the interaction of that light with the materials and structures of the object, and the capture of that light by a sensor that accurately quantifies its spatial, intensity, and spectral distribution.

Most imaging systems utilize lenses and are intended to facilitate the creation of high-fidelity visual replicas of objects that are as close in appearance to the objects themselves when displayed or rendered in some manner. An imaging system may make use of accurate data captured after interaction of light with the object for other purposes, e.g. to create a rendering that enhances particular properties of the object. The source of the light energy that creates the image may be within or outside of the object. Very often, the light that creates the image is some combination of light that is emitted by the materials of which the object is composed, is transmitted through the object, and is reflected from the object. Imaging data resulting from these interaction of the object with light may be identified and isolated by various means, and each of these interactions may be used to provide information in the image about the object.

Detectors that create images are often sensitive to a specific range of light wavelengths. The interaction of the object with different light wavelengths may be recorded in the image. A great deal of information about the object may be inferred from the interaction of the object with different light wavelengths and the image record of these interactions. For example, the color of an object that we see with our eyes may be recorded in captured images if the object is illuminated with different wavelengths of light in the range of wavelengths visible to our eyes.

Most color photography illuminates objects to be photographed with a broad range of light wavelengths that are all simultaneously illuminating the object. Light of this nature is perceived by the human eye as nominally white. Sometimes, the broad range of wavelengths is comprised of multiple narrow bands. Most often, the light is comprised of a more or less continuous spectrum of wavelengths over the broad range. We refer to this light as broadband light, and we also perceive the color of this light to be nominally white.

Most color photography records the color of an image by placing color filters between the scene being photographed and the medium that records the light. The filters are often placed between the lens and the sensor when the sensor is an electronic sensor. (In film, the filters are integrated into the recording medium.) Most often in digital color cameras, the filters are applied to the surface of the sensor. Some cameras use a property of the silicon sensor itself to take the place of the filters. This property is the property that results in red light penetrating the silicon deeper than blue light. Less often, filters are place in front of the sensor, or even less often still, in front of lens. In these 2 cases, there are typically prisms or 3 or more filters and a beam splitter with multiple sensors, or a single sensor requiring multiple image captures through each of different color filters in succession. Multiple filters are sometimes combined with monochrome sensors and sometimes with decaled color sensors to acquire additional color information with sequentially captured images through different color filters.

It is also possible to record color information by placing the filters between the scene and the source of the light. In this case, as in the case of multiple filters placed substantially in front of a single sensor or between the lens and the scene, multiple image captures are required to obtain a color image. Equivalently, it is possible to replace the broadband light and color filters with light sources that are inherently colored at their source, such as LEDs. LEDs are available in a range of colors that cover and in fact exceed the visible portion of the spectrum. The bandwidths of colored LEDs are typically much narrower than the bandwidths of color filters required to produce reasonably accurate color over a wide range of colors found in nature. If 3 different colored illuminants (for example, R, G, B LEDs) are used to illuminate scenes which have a color space comprised of 3 primaries, such as color transparency film, prints from color film, or printed media printed with CMYK color process inks, very accurate color renderings may be made from the captured data.

However, if the scene is comprised of colors found in nature or created artificially by a plurality of dyes and pigments and the like, it is often extremely difficult to create highly accurate color renderings from images captured using 3 color filters created from available filter materials or using 3 colored illuminants such as LEDs. The reason is that the spectral shapes of the filter pass bands and the spectral shapes of the colored light sources do not match the photopic response shapes of the receptors of the human eye.

It is possible, by using greater numbers (greater than 3) of filters with different pass bands, or greater numbers of different colored illuminants, or combinations of different filters and different colored illuminants, to overcome this problem. The use of a plurality of spectral bands greater than 3 to accurately measure and record a single color at a time is well known and is exploited often in color measuring instruments such as spectrophotometers.

Use of more than three bands is much less often exploited in the capture of images. Color measuring instruments such as spectrophotometers measure a single value of color over the field of view of the instrument; image capture instruments typically measure millions of values of color over the field of view of the instrument. A spectrophotometer or colorimeter which requires one second to measure a single color might be practical. A camera with one million pixels that would require one second to measure the color of each pixel would not likely be practical. A one megapixel camera can be considered in a sense to be a colorimeter which is required to make one million color readings per image capture.

In recent years, as imaging sensors have become more capable and computers have become much faster, the use of greater numbers of spectral bands to capture images has been explored. Most of these explorations have involved using a plurality of filters to provide the spectral bands. Far fewer explorations have involved using different colored illuminants to provide the spectral bands.

Light in the optical region of the electromagnetic spectrum can interact with materials by several principal mechanisms; these are characterized by the physical processes governing the interaction. One process governs both reflection and transmission of photons. Importantly, a linear mathematical relationship describes the reflection-transmission process. Linearity is central and of critical importance in many quantitative treatments of light measurements of the reflected light. An essential, defining property of the reflection-transmission process is that the wavelength of reflected or transmitted photons is unchanged.

Absorption of light incident upon a medium is a different interaction process between light and a medium. Absorption entails the elimination of incident photons, which are captured by the medium, thereby reducing the number of photons, or intensity, of the light. Often, the absorption of a photon excites further processes in the medium that result in the emission of one or more photons of different energies and wavelengths than those of the incident photon responsible for exciting their emission. Usually, these emitted photons have energies substantially different from the incident, or excitation, photons. Processes of these types are termed “luminescent” processes. Of the several luminescent processes that can occur, fluorescence is the most common, and is of most interest in imaging and color reproduction. While fluorescence is only a particular type of luminescence, in this document the term fluorescence is used in place of the term luminescence, due to the ubiquity of its use in the literature of the imaging and reproduction community.

The key characteristic of fluorescence, as it pertains to imaging and reproduction, is that the photons that excite the emission have shorter wavelengths than those that are emitted. Consequently, these are termed excitation and emission photons, respectively. Similarly, the terms excitation and emission wavelengths are understood to refer to the wavelengths of the excitation and emission photons, respectively.

While the process of fluorescence can take place during the interaction of particular wavelengths of light and particular types of materials, it is exceedingly rare for fluorescence alone. For opaque materials, it is accompanied by reflection of incident photons; for transmissive, or translucent, materials, it is accompanied by both reflection and transmission of incident photons

Many detectors, including cameras, scanners, and spectrometers, are sensitive to a range of wavelengths that spans both incident and fluorescently emitted photons. Consequently, in the presence of light at both incident and fluorescently emitted wavelengths, the signal measured by the detector includes contributions at both wavelengths. If the relative contributions at different wavelengths are to be determined from a single measurement, the detector or detection system must include some means for discriminating between the photons of the various wavelengths. This is most commonly achieved through the use of filters. Passband transmission filters allow photons within a selected range of wavelengths to be transmitted through the filter so that photons so-transmitted they can reach and be measured by the detector; photons outside of the selected range of wavelengths are absorbed or rejected by the filter and are thereby prevented from being measured by the detector. By sequential use sets of filters of selected during repeated measurements, it is possible to determine the relative amounts of light in selected wavelength ranges that are present in a light signal containing a broad range off wavelengths. Based on the measured data, absolute quantities of light in selected wavelength ranges can be further determined by utilizing detector sensitivity and filter pass band calibration data during calculations.

### REFERENCES

### US Patents

| | | |
|---|---|---|
| 5,319,472 | Jun. 7, 1994 | Hill et al. |
| 5,479,524 | Dec. 26, 1995 | Farrell et al. |
| 5,790,281 | Aug. 4, 1998 | Knox et al. |
| 5,793,884 | Aug. 11, 1998 | Farell |
| 6,198,107 | Mar. 6, 2001 | Seville |
| 6,278,521 | Aug. 21, 2001 | Jablonski et al. |
| 6,512,236 | Jan. 2, 2001 | Seville |
| 6,771,400 | Aug. 3, 2004 | Kleiman |
| 6,839,088 | Jan. 4, 2005 | Dicarlo et al. |
| 6,844,931 | 25-Nov-02 | Ehbets |
| 6,914,250 | Jul. 5, 2005 | Seville |
| 6,920,244 | Jul. 19, 2005 | Rosen et al. |
| 7,079,284 | 10-Oct-01 | Kawakami, et al. |
| 7,092,097 | 8-Mar-06 | Cargill, et al. |
| 7,119,500 | Oct. 10, 2006 | Young |
| 7,119,501 | Oct. 10, 2006 | Young |
| 7,119,930 | Oct. 10, 2006 | Carstensen et al. |
| 7,145,657 | 8-Mar-06 | Peterson, et al. |
| 7,251,031 | 24-Jan-05 | Lewis, et al. |
| 7,262,853 | 23-Sep-03 | Peterson, et al. |
| 7,312,874 | 1-Jul-05 | Berner |
| 7,411,177 | 31-Jan-07 | Kobayashi |
| 7,420,680 | 16-Nov-05 | Shannon, et al. |
| 7,443,506 | 9-Nov-04 | He, et al. |
| 7,443,508 | 17-May-06 | Vrhel, et al. |
| 7,446,299 | 4-May-06 | Kobayashi |
| 7,474,402 | 23-Mar-06 | Shannon, et al. |
| 7,474,402 | Jan. 6, 2009 | Shannon |
| 7,489,396 | Feb. 10, 2009 | Vrhel et al. |
| 7,554,586 | Jun. 30, 2009 | Imai etal. |
| 7,555,396 | Jun. 30, 2009 | Mestha |

### Other References

Tzeng, D.; Berns, R. S., Spectral-based ink selection for multiple-ink printing II. Optimal ink selection, Proc. of Seventh Color Imaging Conference: Color Science and Engineering, Systems, Technologies and Applications, IS & T/SID, Color Imaging Conference, Springfield, Va., United States, pp. 182-187 (1999).
Hardeberg J, “Acquisition and reproduction of color images: colorimetric and multispectral approaches”, [dissertation], Dissertation.com (2001).
Conde J, Yamaguchi M, Ohyama N, Baez J, “CIE-XYZ fitting by multispectral images and mean square error minimization with a linear interpolation function”, Revista Mexicana de Fisica 50(6): 601-607 (2004).
Berns R S and Taplin L A, “Evaluation of a Modified Sinar 54M Digital Camera at the National Gallery of Art, Washington D.C. during April, 2005” [report], https://ritdml.rit.edu/bitstream/handle/1850/4350/LTaplinTechReport07-2005.pdf?sequence=1 (2005).
Lakowicz, J R, “Principles of Fluorescence Spectroscopy”, 3rd ed., Springer, New York, (2006).
Robert A. Schowengerdt, “Remote sensing: models and methods for image processing”, 3rd ed., Academic Press, London (2007).
Dissing B S, Carstensen J M, “Optimal Color Mapping of Multispectral Images”, Proceedings from Gjøvik Color Imaging Symposium 2009: 31-38 (2009).
Christens-Barry W A, Boydston K, Easton R L Jr., “Evaluation and compensation of fluorescence for spectral imaging of art materials and historical documents”, Proc. SPIE 7528:75280M-1-75280M-8 (2010).
Fauch L, Nippolainen E, Teplov V, Kamshilin A A, “Recovery of reflection spectra in a multispectral imaging system with light emitting diodes”, Optics Express 18:23394-23405 (2010).

### BRIEF SUMMARY OF THE INVENTION

This disclosure describes an imaging system using colored illuminants, or colored illuminants together with filters, or combinations of several of these, to generate and control the spectral distribution of light to which an image sensor is exposed; a method of multi-spectral image capture for recording the responses of a scene to variety of such spectral distributions of light; and a method of deriving color images from multi-spectral image captures.

In one exemplary form, the multi-spectral imaging system comprises: an electronic image sensor, optical elements used to form an image of a scene on the focal plane of the sensor, light sources and/or light filters for controlling the spectral distribution of light impinging on the scene and or the sensor, light directors electronic and/or manual controls for the image sensor, optical elements, and a computing device equipped with software allowing a user to operate and monitor the status of various components of the system.

In particular the above-mentioned software communicates with electronic controls of the image sensor, optical elements, and light sources and/or filters, permitting the user to initiate image capture, determine deployment of light sources and/or filters, and cause images to be stored in an electronic storage device and/or be shown on an electronic display device. Moreover this software includes modules dedicated to image-processing operations discussed below.

The system produces one or more grayscale images of a scene, recording the response of the scene to light of a variety of user-selected spectral distributions. With the scene, the optical elements, and the light sources kept in constant position, the result is a spectral image stack, such for a given position within an image, the pixels at that position in all of the component images correspond to the same site on the scene. Depending on implementation, the lights incident upon a subject scene and upon the image sensor may have spectral distributions concentrated in wavelengths in one or more of the ultraviolet, visible, and infrared regions of the electromagnetic spectrum. For the purpose of deriving color images, spectral distributions concentrated in the visible region are used.

To an image originally recorded by the image sensor, corrections are applied for spatial non-uniformity in sensor response, and interpolation is used to replace data lost due to defective response at isolated pixels. This results in an image whose grayscale levels are essentially in direct proportion to incident light energy. From images of this kind, additional products of the system, either grayscale or color images, may be derived by processes outlined below.

These processes, some involving calculations performed by software resident in the computing component of the system, include the following: compensation for spatial non-uniformity in lighting of a scene and/or in the optical signal reaching the image sensor, computation of color-coordinates from a multi-spectral set of grayscale values, and calibration of data used in this computation. These procedures may be supplemented by techniques to detect and measure fluorescence in a scene, and to account for contributions of fluorescence to its color.

To compensate for spatial non-uniformities in lighting and/or optical signal reaching the image sensor, a corrected image may be produced, approximating the image of a subject scene that would result in the absence of the non-uniformities. This is accomplished by first capturing the subject scene and a reference scene under identical conditions, the reference scene being prepared to have optical properties of its surface as spatially uniform as practicable. Then a corrective factor is computed for each pixel of the reference-scene image and applied to the image level of the corresponding pixel of the original subject-scene image, producing the level in a pixel of the corrected image. Each corrective factor is the ratio of an average or typical image level of the reference-scene image to the level at one of its pixels.

A color image of a scene may be derived from a spectral image stack representing the response of the scene to lights of several deliberately controlled spectral distributions in the visual range. Assuming that there are n grayscale images, the derivation is accomplished by linearly transforming, at each pixel, an n-dimensional vector of the grayscale levels into a 3-dimensional vector that represents color according to a tristimulus model of color vision, which can then be converted into any of several standard systems of color coordinates. Application of non-uniformity correction to the grayscale images, as described in the preceding paragraph, permits the same transformation to be used at each pixel. The 3-by-n matrix used to implement the linear transformation is determined by a calibration process based on a spectral image stack that results from imaging a color chart containing samples of known color. One form of the calibration process permits accuracy of color reproduction to be optimized for the color of a designated sample, typically the white sample.

### BRIEF DESCRIPTION OF THE DRAWINGS

FIG. 1 is a diagram of the physical arrangement of major elements of a system embodiment;

FIG. 2 is a diagram depicting an exemplary embodiment of the system of the present invention;

FIG. 3 is a diagram of a light emission module in accordance with one embodiment of the present invention;

FIG. 4 is a diagram of an electronic control module in accordance with one embodiment of the present invention;

FIG. 5 is a flow chart depicting the electrical signal paths between elements of a light emission module in accordance with one embodiment of the present invention;

FIG. 6 is a diagram of the elements comprising a light emission module in accordance with one embodiment of the present invention;

FIG. 7 is a diagram of the spectra of a set of light emitting diodes;

FIG. 8 is a diagram of the CIE XYZ sensitivity functions;

FIG. 9 is a diagram of the CIE Illuminant D50 and the CIE Illuminant D65 spectra;

FIG. 10 is a diagram of a spectral image stack;

FIG. 11 is a diagram of the components of a color image;

FIG. 12 is a diagram of a spectral image stack obtained from a scene that includes a standard color reference chart;

FIG. 13 is a diagram of a spectral image stack obtained from a scene that includes a painting and a white sample.

### DETAILED DESCRIPTION OF THE INVENTION

### Image Capture System Description

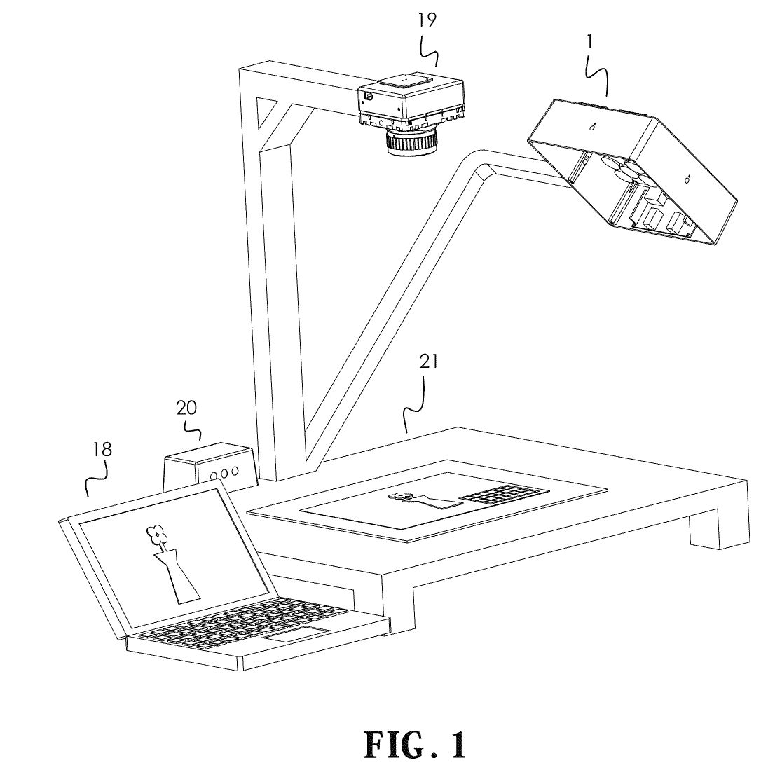

The system to which this invention relates comprises elements embodied in the components schematically shown in FIG. 1. The elements are an imaging device for creating a digital image of light from a scene, a light source to illuminate the scene, a light director that causes light from the light source to illuminate the scene in a controlled fashion, a light director that causes light from the scene to form an image that may be detected by the imaging device, memory for storing images and calibration data, some of which calibration data is derived from images captured by the imaging device, and an adjusting device which adjusts light signals based on light signals detected by the imaging device and the calibration data.

The detailed description given here includes a description of the best implementation of the invention presently contemplated. This description is intended to exemplify the invention for illustration purposes, so that in conjunction with the accompanying drawings and by reference to this description one skilled in the art may be advised of the advantages and construction of this invention. This description is not intended to be understood in a limiting sense. Variant embodiments for particular uses or contexts may become evident to one skilled in the art who has learned from the teachings herein.

An exemplary form of the imaging device is a digital camera back or digital camera, though the lens of the digital camera is an exemplary form of the first named light director. Exemplary forms of the array of sensors are CCD and CMOS arrays. The arrays can be one dimensional or 2 dimensional arrays. A particularly useful form of an array is one which has no color filtration integrated with the array. Such sensor arrays are often referred to as monochrome sensors.

An exemplary form of light source is drawn from a class of devices referred to as solid state light sources (SSL). A particular and exemplary type of SSL is an array of light emitting diodes (LED). Different emitters in the array emit light in different wavelength bands, i.e., colors. The array is capable of controllably emitting different wavelength bands at different times. In an exemplary form, a single wavelength band or a plurality of wavelength bands may be selected for emitting at a given time, each band emitting at a selectable power, and different wavelength bands or pluralities of wavelength bands may be selected for emitting in a controllable sequence.

Properties of light emitted by an SSL may be altered by subsequent interaction of the emitted light with a device. This interaction often takes the form of transmission of the light through the device or of reflection of the light by the device. These devices are referred to as modifiers. Exemplary forms of modifiers are directors, which modify the directional properties of light, polarizers, which modify the polarization properties of light, and filters, which modify the spectral composition of the light.

Different exemplary forms of light directors for directing light from the light source on, into, or through the scene are lenses, reflectors, optical fibers, and diffusers. Such directors may be discreet, with different directors associated with different emitters in the array of emitters or different colors of light, or combined, with a single director directing light of different colors or from a plurality of different emitters. As mentioned, an exemplary form of the director (d) is a lens. The lens may work by refraction or reflection.

An exemplary form of the memory elements is the memory typically found in a computer or digital controller. The memory may be volatile or non-volatile, dedicated or general purpose. The memory may be modules discreet from other computer or controller system elements, or it may be integrated into the elements, such as memory in a Programmable Logic Device. In some exemplary forms, memory of different types may store the data. For example, data may be stored somewhat permanently on hard drive memory, then loaded into volatile random access memory for control, adjustment, and manipulation.

An exemplary form of the adjusting device in (i) is a computer together with appropriate software and interfaces that enable the computer to adjust data and appropriate elements of the system. In one exemplary form, the computer is loaded with appropriate software and some preliminary calibration data associated with the imaging device and light source. Images are then captured of one or more scenes containing targets of known spectral reflectance properties. Images are also captured of a scene of which an accurate color digital color image is desired. In some cases, the targets of know reflectance properties may be placed in the same scene of which a color image is desired. Calibration data is derived from images captured of the targets. The calibration data derived from captured images, and calibration data previously known are used to adjust captured image data and calculate from the captured images a color image representing the scene. In a further exemplary form, the calibration data is used as a basis for adjusting individually or in combinations the imaging device, the lights, or the directors.

For example, in the case that the light source is an array of LEDs, the power and/or exposure duration of each different wavelength band emitter is adjusted such that images captured of a known white target in the scene under each of the different illuminants or illuminant combinations register equally by the imaging device. After these adjustments, images of the scene are captured using the adjusted light power/exposure durations By this means, the signal-to-noise ratios of all image captures are optimized.

One skilled in the art will recognize that the linear relationship governing both reflection and transmission ensures that image data that measures transmitted light may be treated in a manner that is equivalent to that used for image data captured using reflected light. The present patent describes the capture and use of reflected light images only, for the purpose of brevity and not in a limiting sense. The imaging device and light sources of the present patent may be choosably located and oriented to accomplish the capture and treatment of reflection or transmission images.

An exemplary system that embodies the invention claims is as follows:

A commercially available medium format digital camera back commercially known as a MegaVision E6 mono is used as the imaging device. The image sensor in the back is a 7216×5412 monochrome CCD array. The E6 is integrated into a camera system with addition of a digitally controlled shutter, a digitally controlled aperture, a lens, and a rail and bellows arrangement that enable adjusting the distance between the lens and the focal plane so that the camera may be focused on scenes of different sizes at different distances.

A light source is fabricated using commercially available LEDs. The light source integrates LEDs of as many as 9 different visible wavelength bands, of as many as 3 different ultraviolet wavelength bands, and of as many as 6 different infrared wavelength bands. Multiple LEDs of the same wavelength bands are used to achieve sufficient light energy to expose a reasonable size area at a reasonable aperture with reasonable exposure durations. Using 4 5-watt LEDs in each of the visible wavelength bands enables nominally one second exposures at f11 over a roughly 20″×24″ field of view. In the exemplary system, each 5-watt LED is integrated with a lens that controls the beam width emitted from the LED, and each lens is fitted with an interchangeable diffuser. Several dozen LEDs are integrated into a single panel housing, and the housing is adjustably oriented relative to the scene to optimally direct the light onto the scene. Additionally, the entire housing may be fitted with a single diffuser.

The digital back, the aperture, the shutter, and the light panels are connected to a commercially available computer using standard digital interfaces that enable the connected devices to communicate with the computer, and enables the computer to control and adjust the connected devices. The E6 is connected via an IEE1394 interface and the other shutter, aperture, and light panels are connected via USB interfaces.

Custom software resident on the computer enables opening and closing the shutter at selectable times, setting the aperture to selectable openings, turning on each wavelength band of LED at a selectable time at a selectable power for a selectable duration, initiating image capture at selectable times, assessing, adjusting, viewing, saving captured image data, deriving calibration data from captured image data, adjusting captured image data based on data derived from captured image data and other selectable criteria, and deriving color images from the images captured. The custom software automates the entire capture sequence, enabling an operator to capture and process a pre-determined sequence of arbitrarily many images with a single input equivalent to tripping a shutter release on a camera or pressing a start button on a copier. If appropriate calibration data is available at the time of capture, color images may be derived automatically without further input from an operator.

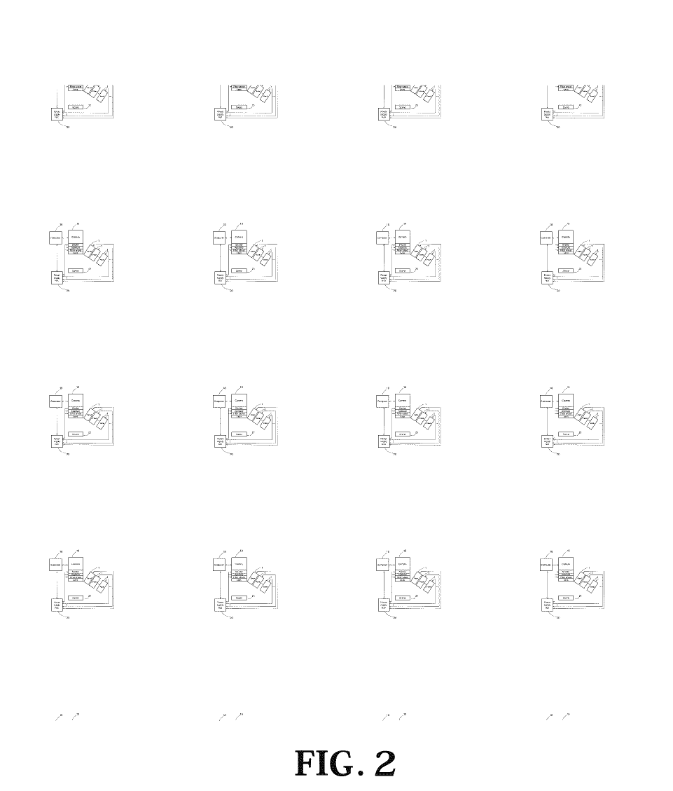

FIG. 2 schematically depicts an exemplary embodiment of the claimed multi-spectral and colorimetric imaging system. The subsystems comprising this system include a camera subsystem 19, a single or a plurality of spectral lighting modules 1, a host computer 18, and a power supply hub 20 subsystem. These subsystems are configured so that, by means of programs and data stored among the subsystems and by utilizing communications between them, digital images of the scene 21 may be acquired, adjusted stored, and used to derive further data and images.

A spectral lighting module is comprised of an array of light sources that emit light in narrow spectral bands and electrical components for provision of power to the light sources. Light emission bands with a full-width-at-half-maximum (FWHM) intensity of 10 nm to 50 nm width, at central wavelengths spanning the wavelength range of 365 nm to 1050 nm, are desirable for many spectral imaging applications due to their coverage of the full wavelength range of interest with useful spectral resolution.

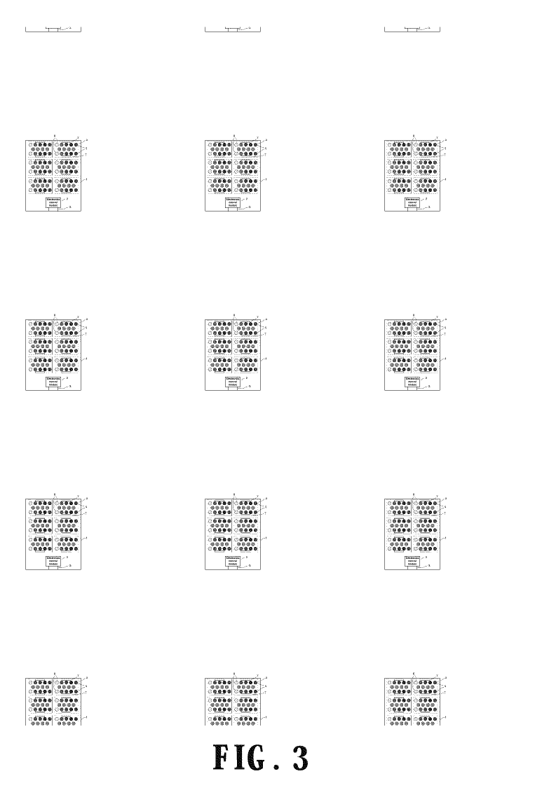

In FIG. 3, the components and organization of a spectral lighting module 1 of the spectral imaging system are depicted. A spectral lighting module 1, also termed a “panel” herein, is comprised of an electronics control module 2, an electrical connector 3, and a single or a plurality of lighting subpanels 4. The panel is self-contained in a rigid housing that provides mounting points.

Each subpanel 4 is comprised of a single or plurality of light emission modules 5, also termed “LEMs” herein, that can controllably emit light within a single narrow wavelength band, a single or plurality of LEMs 6 that controllably emit light within a narrow wavelength band that is different from the emission band of LEMs 5, and electrical connectors 7 to which electrical cables are connected so that electrical power may be provided to the light emission modules 5 of the subpanel via circuit paths that connect a single or a plurality of LEMs of the same narrow wavelength band.

In a preferred embodiment, the number of subpanels comprising a panel is in the range of 2 to 6. Further, in this preferred embodiment, the number of LEMs of a subpanel that emit in a given narrow wavelength band is in the range of 2 to 6. Further, in this preferred embodiment, the number of narrow wavelength bands that can be emitted by the LEMs comprising a subpanel is in the range of 5 to 16. In this preferred embodiment, subpanels may be comprised of different combinations of LEMs of the narrow wavelength bands that are used in a panel.

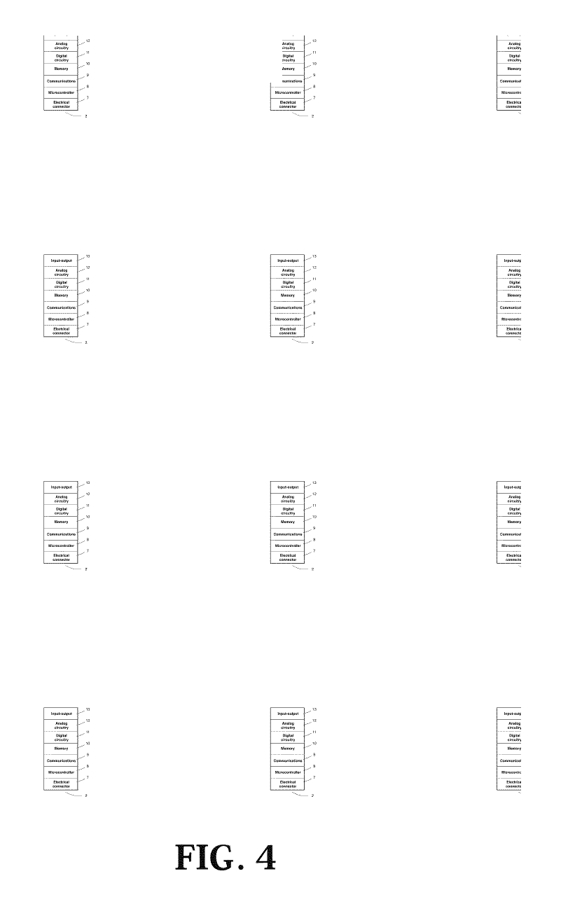

FIG. 4 depicts the major functionalities comprising an electrical control module 2, also termed an “ECM” herein. Electrical power is routed from the panel electrical connector 3 to the ECM 2 via internal wiring. A microcontroller provides communications 9 functionality required for communication with the host computer 18, volatile and non-volatile memory 10 for storage of firmware programs that control the LEMs, digital circuitry 11, and input-output 13 interface ports. The micro-controller firmware programming controls digital circuitry 11 to drive analog circuitry 12 that regulates the emission of light by the LEMs.

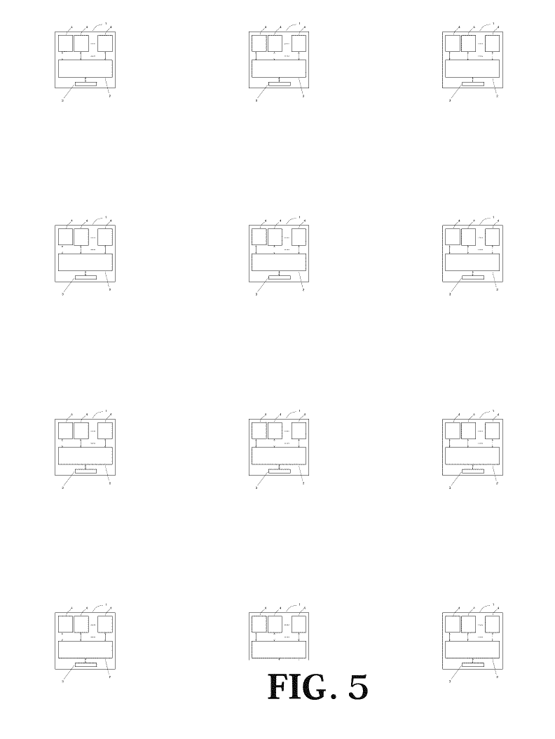

LEMs are connected by internal wiring that create circuit paths between the ECM and the LEMs. An exemplary circuit in which all of the LEMs are connected to the ECM using a parallel circuit topology is indicated by double-headed arrows in FIG. 5 between the input-output 13 interface ports of ECM 2 and each LEM 4. It will be appreciated by one skilled in the art that a particular electrical circuit topology may be selected from a set of many variant serial-parallel circuit topologies that satisfy electrical circuit requirements.

Circuitry for providing electrical power and for bi-directionally distributing communications commands and data between the host computer 18 and components of the camera subsystem 19 is packaged into a single power supply hub module 20, also termed “PSH” herein, shown schematically in FIG. 1. Alternating current (AC) or direct current (DC) is provided to said from an external source, preferably a wall socket that provides AC power at 110 V or 220 V or from battery power sources that provide DC power at a voltage in the range of 6-48 V. In a preferred embodiment, the PSH is able to furnish 65 watts of regulated power at 32 V DC. Said PSH contains a Universal Serial Bus (USB) hub that routes said bi-directional communications signals between said host computer and said peripheral devices. Peripheral devices are preferably connected to said USB hub using cables that can be plugged into USB sockets built into said USB hub. It is particularly advantageous and preferable to distribute power distribution and communications signal distribution using a single cable that connects with said peripheral devices using a single connector at each end. In order to simplify the process of connecting said combined power supply and hub module with said peripheral devices, it is preferable that the connectors have identical physical and wiring configurations allowing the cable to be connectable and operable regardless of which terminal is connected with said PSH and with said peripheral devices.

Those skilled in the art will recognize that other wired or wireless hardware, devices, protocols, and software may be used as an alternative means of providing said communications between any combination of the host computer 19, power supply hub 21, and panels 1. One embodiment of a wireless communications means uses Zigbee communications together with cables that only carry power to each said peripheral devices. In this embodiment said power supply hub is replaced by a module that provides a DC power supply and sockets for power distribution, a single USB socket for USB cable connection to said host computer, a communications conversion means for converting USB signals received into Zigbee communications signals, and a Zigbee master communications controller that manages wireless communications between said module and said peripheral devices.

Said micro-controller provides bi-directional communications functionality for communications with external devices; the host computer is the primary external device that utilizes said bi-directional communications functionality for the transmission and reception of data and commands. Said micro controller further provides non-volatile memory (ROM and EEPROM) and further provides volatile memory (RAM), that stores communicated data and commands. Said non-persistent memory is also used for storage of data that is generated by the micro-controller.

Said micro-controller has digital and analog input-output functionality that utilizes data and commands received from said host computer together with data stored in said memory to effect control of said internal and external circuit elements in order to transmit and receive signals that are sent to further circuitry in said panel. Said memory contains firmware programs that control the flow of signals between said micro-controller and said further circuitry.

The analog and digital circuits of the ECM control the timing, duration, and amounts of electrical power that causes the LEDs to emit light. In a preferred embodiment, instantaneous power is regulate by choice of a particular amount of current that controllably flows through LEDs that have been directed to be turned on at particular times. In this preferred embodiment, average power is controllably regulated and delivered using pulse width modulation (PWM). PWM is a method that allows regulation of average power levels over a selected duration by utilizing repeated cycles of a duration that is short relative to the selected power delivery duration. During each said short cycle, power is on at a fixed instantaneous power levels for some fraction of the said short cycle duration and the power level is turned off for the remaining fraction of said short cycle duration. In this embodiment, a cycle time in the range of 0.2-2.0 milliseconds is preferred, as this range is sufficient to ensure that selected average power levels can be accurately delivered for said selected power delivery durations in the range of 10 milliseconds to 2 minutes.

In another exemplary embodiment each panel can contain further analog and digital circuits that are further used to drive and receive input from sensors. In this embodiment, temperature sensors can be used to further regulate the peak or average power of the LED light emission. In this embodiment, orientation or position sensors can be used to capture data describing the orientation or position of the panels.

It is desirable that the illumination of the scene 21 be as spatially uniform across the scene as is practical. The intensity of light emitted by most LED devices diminishes with increasing distance from the emission axis.

It is desirable that a panel that utilizes said array of LEDs of multiple central wavelengths utilize multiple LEDs of each said central wavelength to improve the illumination uniformity at the target object. In a panel, the multiple LEDs of a given narrow wavelength band are spaced at regular intervals in row and column fashion to achieve improved illumination uniformity. The LEDs of a given wavelength may number from 2 to 24 in order to provide the desired level of uniformity at sufficient intensity for target objects ranging in size from 2″ to 27″ in length by 2″×36″ in width. For objects less than 20″ by 24″ in extent, it is desirable to utilize 4 LEDs of each visible and ultraviolet wavelength and 2 LEDs of each infrared wavelength in an LED array.

In a preferred embodiment, in order to maximize the uniformity of the spatial intensity distribution at the object that is being illuminated, the plurality of SSLs of each particular wavelength are spatially distributed in a lattice-like rectilinear grid. In an exemplary embodiment, one or more LEDs of each wavelength are grouped into single clusters of small size having length and width ranges of 0.5-4″ and 0.5-6″, respectively. In this embodiment, a plurality of clusters is in turn arranged into a lattice-like lattice with horizontal and vertical spacing ranges of 1-6″ and 1-8″, respectively, resulting in said lattice-like spatial distribution of all LEDs having a particular wavelength. A rectilinear lattice of LEDs containing 6 clusters is depicted in FIG. 2, each cluster being comprised of seven pairs of LEDs, with each pair of LED's differing in wavelength. In a variant of this embodiment, said clusters are arranged in a hex lattice with the spacing between clusters in the range of 0.5-6″.

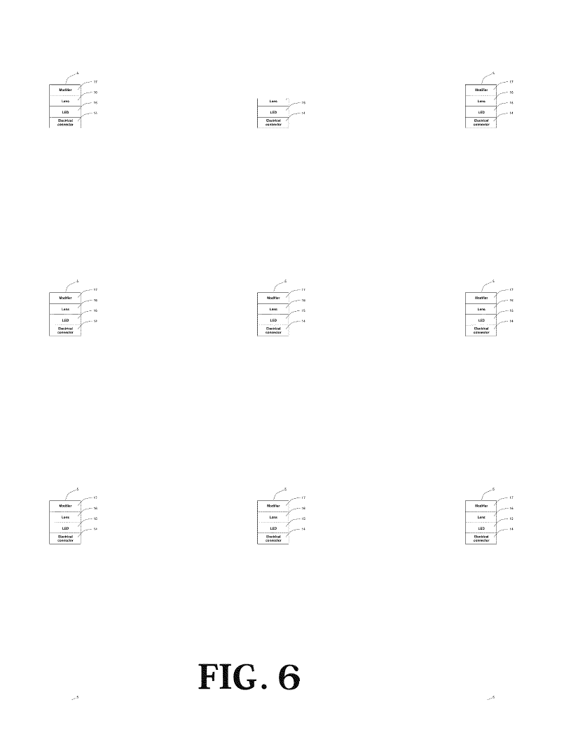

FIG. 6 depicts elements comprising a light emission module 5. In order to increase the fraction of light emitted by each LED 15 that is directed to the region or area of the scene 21 and to further improve illumination uniformity at the scene, an individual lens 16 is provided for each LED. The material, geometry, and focal properties of an individual lens may be chosen in order to improve the performance of a lens used with an LED of a particular emission wavelength. For LEDs used to shape and deliver the emission from ultraviolet LEDs, polymethmethacrylate materials formulated to transmit said wavelengths with minimum attenuation and negligible fluorescent conversion of the emitted wavelength to other wavelengths are desirable. Optical glasses with heightened transmission of infrared wavelengths are desirable for LEDs that emit in the infrared. Lens materials and lens coatings formulated to reduce reflective losses for a lens used with an LED of a particular wavelength will be recognized by one skilled in the art to increase the amount of light emitted by said LEDs that is available following transmission through a lens or other director. The light emission module is further comprised of a single or a plurality of modifiers 17 chosen from a set comprised of diffusers, polarizers, and filters. Releasable attachment points are provided on the lens to allow individual modifiers to be optionally attached to individual LEDs. The diffusion properties of each individual diffuser are adaptably selected to match a desired level of uniformity. Diffusers are commonly characterized by the divergence angle that obtains upon transmission of a collimated incident beam through a diffuser. In a preferred embodiment, diffusers with full-width-at-half-maximum (FWHM) diffusion characteristics of 6° and 12° are used. In an exemplary variant embodiment, holographic light diffusers with selectable anisotropic diffusion properties are used to create different amounts of diffusion along selectable single orthogonal axes.

In a preferred embodiment, global diffusers that transmit and distribute the light emission from a plurality of LEDs that collectively make up an array can be used separately and in conjunction with said individual diffusers. One or more of said global diffusers can be selectably placed at a selectable location in the optical path between a single panel or a plurality of panels and the object.

The appearance of scenes with significant surface relief, such as oil paintings or collages, obtains in part from shadow effects that occur under highly directional lighting conditions that are desired for display of objects in museums and galleries. Capture of these surface height variation effects in images is diminished in highly diffuse light. In order to capture and reproduce these effects, it is desirable to utilize lighting with selectably variable degrees of diffusion and selectably variable degrees of directionality.

In an exemplary embodiment of the system, the spectral properties of the scene at higher spectral resolution than may be obtained using the unmodified emission spectrum of an LED are measured by using optical filters commonly referred to as “narrowing” filters to attenuate light of particular wavelengths that pass through them. Said narrowing may be used to reduce or eliminate wavelengths within the emission spectrum of the LED. Said releasable attachment points can be used to position narrowing filters separately or in conjunction with diffusers. Narrowing filters or filters at with different wavelength pass bands may additionally or separately be used in front of the camera lens to measure spectral properties of light that is fluorescently emitted by the scene or to measure the spectral properties of light reflected or transmitted by the scene.

In order to measure of the polarization properties of target regions, another embodiment utilizes optical polarizers to define the polarization state of light produced by the LED array. Said releasable attachment points can be used to position such optical polarizers separately or in conjunction with diffusers. In this embodiment, additional polarizers may be placed in front of the camera lens, separately or in conjunction with polarizers used with the LEMs to measure the polarization properties of the detected light.

Another exemplary embodiment that would be recognized by those skilled the art would utilize a single panel, termed a “master” panel, in conjunction with one or more further panels, termed “slave” panels. In this embodiment, communication and control functionalities in the slave panels could be controllably bypassed or deactivated. Power signals can be provided by the master panel to the slave panel LEDs by wire cables connected directly to the LEDs in the same manner as in master panels using a parallel circuit topology. In a further variant of this embodiment, the unused communication and control functionalities and circuitry would be omitted during construction of said slave panels.

In the preferred embodiment, panels are housed in a compact enclosure having length, width, and depth dimensions in the ranges of 4-16″, 4-16″, and 2-6″, respectively. The enclosure is constructed of aluminum that is rigid and has a black outer surface of the type that is commonly used for photography and darkroom equipment, and that is non-specular in its reflectance properties in order to minimize undesirable reflected light. The enclosure is constructed with openings that accept standard fittings and attachment points of the type commonly used with photographic, theatrical, and darkroom lighting fixtures. A preferred fitting is the standard ⅝″ diameter spud. Another desirable fitting is a standard yoke-type fitting of the type often used in theatrical and film lighting fixtures. These fittings facilitate the adjustment of the angular orientation of the panel and allow attachment of the panel to standard lighting tripods, booms, and stands.

### Capture Method Description

There are 3 calibration targets to which this method description refers:

### 1 Color Calibration Target

### 2. Flat Field Target

### 3. White Target

### 1. Color Calibration Target

The Color Calibration Target comprises a number of different color samples whose spectral reflectance or transmittance properties are known, and whose colors are somewhat broadly distributed over visible color space. An example of such a target is the commercially available and widely used X-rite ColorChecker reflectance color target.

Use of a color calibration target is required in the method of this invention for deriving color images from a plurality of multispectral image captures. Images are captured of a Color Calibration Target using substantially the same spectral wavelength bands as are used to capture images of the object scene, and from these captured images calibration data is derived that is used by the method of this invention to derive a color image from the spectral image captures of the object scene.

It is often the case that a color calibration target is small compared to the size of the object scene. In this case, it is sometimes practical to insert the target into the object scene, for example, near the edge of the scene. It is also often the case that it is impractical to insert the target into the object scene; the color calibration target in this case is captured in another set of multi-spectral image captures and the derived calibration data is applied without the benefit of the color calibration target being present in the object scene.

### 2. Flat Field Target

The Flat Field Target is a surface of uniform reflectance or transmittance whose size substantially fills the scene. Images of this target are used to evaluate spatial uniformity of the illuminant(s) on the scene, evaluate non-uniformity of the scene-to-sensor light director, and evaluate spatial non-uniformity of the image capture devices response. Captured images of this target are used to adjust captured data of the scene to compensate for spatially non-uniform distribution of light on the scene and spatially non-uniform radiometric response of the scene-to-sensor light director and spatially non-uniform radiometric response of the imaging device. If the Flat Field Target is a reflective target, it is usually desired that the reflective surface be as Lambertian as is practical, and if the target is transmissive, it is desired that it be as diffuse as is practical. While the flat field target is nominally white, it is not required that it be, and indeed it is not required that it's color be known. If it's color is known, it can be used additionally to evaluate and adjust the light intensity illuminating the scene.

If the spatial non-uniformity of the scene lighting, image device response, and light director response are all within acceptable limits, the Flat Field target may not be required. In practice, for desirably accurate images to be captured, it usually is required. Spectralon, a commercially available polymer, and smooth, matte surface inkjet paper are examples of flat field targets. It is of note that one of causes of non-uniform imaging device response is small dust particles near the focal plane; flat field corrections derived from captured images of a flat field target can eliminate artifacts caused by such particles in the captured images.

### 3. White Target

The White Target is a surface of uniform reflectance or transmittance whose color is known and in the preferred embodiment of the method is nominally white. An example of a white target is the white patch of the above cited ColorChecker target. Other examples are the flat field targets cited above, though in practice the white target would be a small piece of such targets, intended normally to occupy a small fraction of the scene rather than substantially the entire scene as is the case with the flat field target. Besides normally differing in size from a flat field target, the white target is additionally constrained in that its color must be known. If the White Target reflects (or transmits, in the case of a transmissive white target) light of all colors equally, its use is simplified.

Calibration data derived from multi-spectral image captures of a White Target is used to adjust the color of a color image derived from multi-spectral image captures. If the spectrally captured image exposures of the scene from which the color image is derived are substantially same as the exposures of the calibration target images used to provide calibration data to the algorithms that derive the color image, a White Target is not required to obtain an accurate color image.

If, however, the exposure of any of the multi-spectral image captures differ between the series of image captures of the calibration target and the series of image captures of the object scene, use of a white target is indicated to compensate for the difference(s).

It is more frequently the case that a white target can be placed unobtrusively in the object scene than can a color calibration target, as the white target can be considerably smaller than the color calibration target. It is also frequently the case that the difference in capture exposures is negligible from one set of image captures to another, so it is practical that no target be present in the object scene.

One skilled in the art in the field of this invention will appreciate in the above descriptions of the image targets and their uses that the method of image capture claimed in this invention is very practical and flexible. The calibration data required to derive accurate color images from multi-spectral image captures of an object scene is derived from captured images of calibration targets. Exacting measurements of the spectral content of the light source(s) are not required.

Calibration data need not be available at the time of the object scene images are captured. However, if derivation of a color image is desired immediately upon capture of the object scene, then either the calibration data must be available at the time the object scene images are captured, or it must be derived from the image data in the object scene captures. The following description of one embodiment of the method is intended to be exemplary, but not exclusive, and one skilled in the art can readily appreciate variations to which the claims of this invention apply. In the following description, it is assumed that it is practical to place a white target in the scene of the object image, that correction for non-uniformities of scene lighting, light directing, or imaging device response is required, and that a color image of the multispectral image captures of the object scene is desired immediately upon capture. The imaging device is assumed to be a camera system which includes a lens digitally controlled shutter and a digitally controlled aperture.

In the first step, the camera is positioned at a desired distance from and in a desired orientation to the scene, the aperture is fully opened, and the scene is brought into focus by adjusting the distance between the lens and the image sensor. The aperture is then set to the desired aperture at which the spectral images will be captured.

A nominally white target is placed in the scene or a representative portion of the scene itself is chosen as a reference, and the lights are positioned such that the distribution of light from each of the different waveband sources is roughly uniform over the scene.

The amount of light in each of the spectral band exposures is set as follows:

A target of known reflectance, typically white though other colors may be used to match an object scene average color, is placed in the scene. A spectral image stack is captured of this target, each image is captured while the scene is illuminated by a different LED color (or a different ratio of LED colors). The values of the reflectance of the white target in the captured images are evaluated. By setting the power and/or duration of each LED exposure, the amount of light energy that exposes each of the image captures is set so that the measured brightness of the reference target in each of the image captures is roughly equal and sufficiently bright to insure good S/N in the captured image.

Setting the values can be accomplished iteratively by guessing and adjusting, or the amounts of exposure of each of the exposures can be calculated by evaluating the original exposures and calculating the amounts of adjustment required to balance each of the several exposures.

The method of calculating is as follows:
1. Choose a desired value for the target brightness, for example, 80% of full scale.
2. Calculate the ratios of each of the reflectance values to the desired value.
3. Multiply each exposure by the inverse of ratio of the captured value to the desired value.
4. Adjust the duration/power of each light by the ratios. Verify that none of the image target values exceed a maximum value.
   The operating software performs these calculations and automatically adjusts the light exposures for each of the image captures.

If the target is known to be of higher reflectance than any part of the scene, the exposing light energy may be increased, while keeping the exposure ratios between the different colored lights constant. This way, the S/N of the image is optimized while maintaining simple calculations. At the expense of more complex calculations, the ratios may be changed to optimize lighting for scene-specific content.

An appropriate flat field target is placed in the scene and a new set of images are captured and saved to disk memory. Flat field corrections are derived from these images and software applies the flat field corrections to subsequently captured images of the object scene.

The Flat Field Target is removed from the scene, and a Color Calibration Target is placed in the scene. A spectral set of images of the Color Calibration Target is captured, Flat Field corrections are applied by software as the images are captured, and software derives color calibration data from the flat-field corrected captured images and saves the calibration data to computer disk.

The Color Calibration Target is removed from the scene and if the object (or objects) is not already in the scene (having been covered by the Flat Field and Color Calibration Targets), it is placed in the scene. A White Target is also placed in the scene in an unobtrusive location near the perimeter of the scene. A spectral image set is captured with the light distributions on the scene identical to the distributions present when the images of the flat field target were captured. As the images are captured, flat field corrections are applied by the software. If it is known that the light distribution and exposure conditions are identical to those present at the time the calibration target was captured, a color image is derived immediately from the spectral image set. If changes in exposure of any of the wavelength band captures are suspected, the software is informed of the location of the White target in the image captures, and the software adjusts the colors when deriving the color image from the spectral image set in such a manner that the white target is rendered correctly.

### Color Method Description

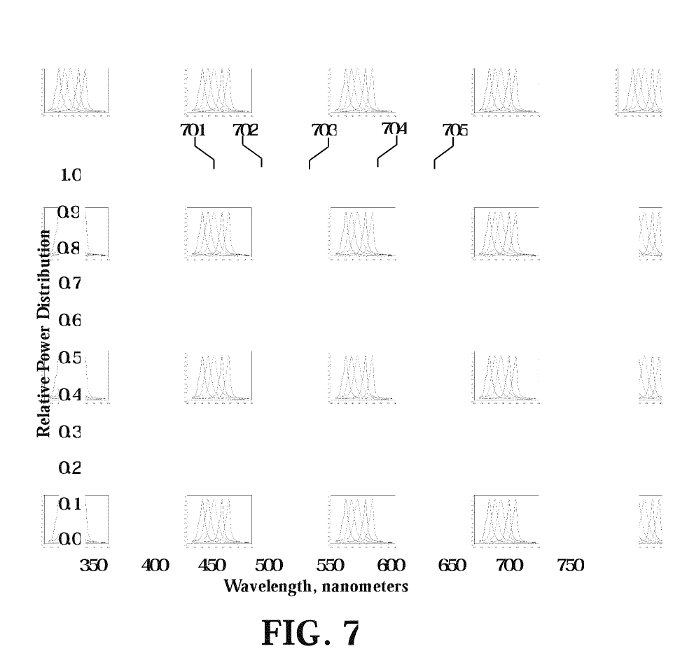

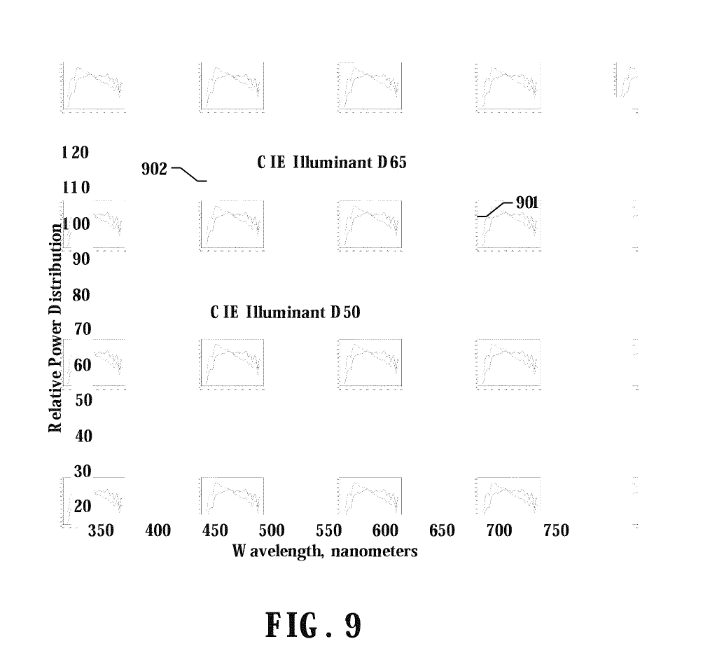

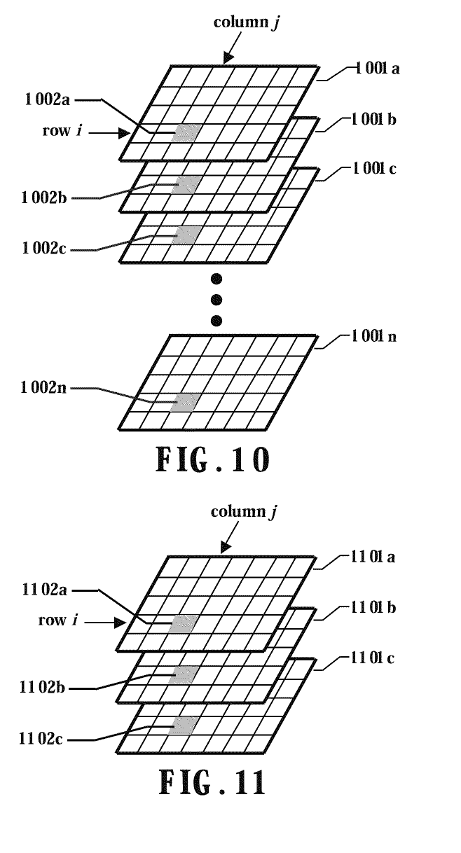

A spectral image stack with some number n of component images 1001a, 1001b, 1001c, . . . , 1001n of a scene, as represented schematically in FIG. 10, can provide sufficient information to allow the derivation of a color image of the same scene. When used for this purpose, the component images will record the response of the scene to light of some spectral distributions s₁, s₂, s₃, . . . , sₙ, concentrated in wavelengths in the visible region of the electromagnetic spectrum, and determined by the deployment of some particular configuration of light sources and or light filters included in the system of this invention. More specifically, if g₁, g₂, g₃, . . . , gₙ are the two-dimensional arrays representing the images, then the image levels g₁(i, j), g₂(i, j), g₃(i, j), . . . , gₙ(i, j) of the pixels 1002a, 1002b, 1002c, . . . , 1002n at some image position (i, j), indicate the responses, to light of these spectral distributions, of a corresponding site on the scene. In an exemplary case, n (never less than 3) could be 5 and the spectral distributions s₁, s₂, s₃, s₄, s₅ could be the ones 701, 702, 703, 704, 705 plotted in FIG. 7. The color of each site on the scene, corresponding to some image position (i,j), can be represented according to some designated system of color coordinates by a three-dimensional vector with components u₁(i, j), u₂(i, j), u₃(i, j). Thus a color image of the scene can be regarded as a sequence of three grayscale images 1101a, 1101b, 1101c whose pixels 1102a, 1102b, 1102c at each position (i, j) have levels equal, respectively, to some color coordinates u₁(i, j), u₂(i, j), u₃(i, j). (See FIG. 11). It should be noted that such an image is intended to represent the color appearance the scene would present as a result of its response to illumination by light of some designated spectral distribution. Typical choices of for such a defining spectral distribution are CIE Illuminant D50 901 and CIE Illuminant D50 902, as plotted in FIG. 9.

It is assumed that color is adequately measured by the XYZ system devised by Commision Internationale de l'Eclairage (CIE). (Either the 1931 or the 1964 version of the XYZ system may be used.) In the products of this invention, color is given scientific, device-independent representation in any of several three-dimensional systems that may be derived from the XYZ system. For each such derivative system, there are some trivariate functions ƒ₁, ƒ₂, ƒ₃ such that if a color is represented by the vector (X, Y, Z) in the XYZ system, then it has an equivalent representation by some vector (U₁, U₂, U₃), with U₁=ƒ₁(X, Y, Z), U₂=ƒ₂(X, Y, Z), U₃=ƒ₃(X, Y, Z). The functions ƒ₁, ƒ₂, ƒ₃ will be publicly available from published color-science literature.

In what follows, an exemplary method for producing a color image from a spectral image stack is presented. In order for this method to be feasible, several conditions must be satisfied regarding the capture and adjustment of the images in the stack: (a) for each component image gₗ of the stack, and for each image position (i, j) corresponding to a site on the focal plane of the image detector, the image level gₗ(i, j) must be a linear function of the cumulative light incident upon that site during the capture of the image; (b) the relative spatial distribution of light energy incident on the scene is the same during the capture of each image, even as the lighting source varies, or else the images have been adjusted so as to simulate this condition; and (c) the light that returns to the image detector from the scene is due to reflection of the light used to illuminate the scene, or, alternatively it is due to transmission of light through the scene.

The linearity condition (a) is satisfied to a sufficient approximation in an image from a CCD detector if that image has been adjusted to compensate for the dark response, bad pixels, and spatial non-uniformities of the detector. In the case of a detector having a different light-to-signal response than the CCD type, the linearity condition could be fulfilled through the use of a linearity-adjustment suited to that response. The second condition (b) is fulfilled by ensuring that, when a spectral image stack is used to produce color, each of its component images will have been adjusted to correct for non-uniformity of scene lighting, by the process discussed elsewhere in this document.

If, in a spectral image stack, the component images of a scene are represented by the two dimensional grayscale arrays g₁, g₂, . . . , gₙ, then a color image of the scene with grayscale image components represented by the three two-dimensional arrays u₁, u₂, u₃ can be derived by a process which, in summary form, consists of two steps. First, at each image position (i, j), estimated XYZ coordinates of the color of the corresponding site in the image, denoted by Xₑ(i,j), Yₑ(i,j), Zₑ(i,j), are computed as linear combinations of the image levels g₁(i, j), g₂(i, j), . . . , gₙ(i, j):

Xₑ(i,j)=α₁g₁(i,j)+α₂g₂(i,j)+ . . . +αₙgₙ(i,j), (1)

Yₑ(i,j)=β₁g₁(i,j)+β₂g₂(i,j)+ . . . +βₙgₙ(i,j), (2)

Zₑ(i,j)=γ₁g₁(i,j)+γ₂g₂(i,j)+ . . . +γₙgₙ(i,j). (3)

Then the actual levels at each position (i, j) in the components of the color image are derived from these XYZ estimates by means of the functions that define the designated color-coordinate system:

u₁(i,j)=ƒ₁(Xₑ(i,j),Yₑ(i,y),Zₑ(i,j)), (4)

u₂(i,j)=ƒ₂(Xₑ(i,j),Yₑ(i,y),Zₑ(i,j)), (5)

u₃(i,j)=ƒ₃(Xₑ(i,j),Yₑ(i,y),Zₑ(i,j)). (6)

In equations (1), (2), and (3), the αₗ, βₗ, and γₗ, for l=1, 2, . . . , n, denote coefficients to be empirically determined by a process to be described below. Note that one set of coefficients is to be used in making the color estimates at every image position. This is possible because of the condition, mentioned above, about the spatial distributions of scene lighting: they are the same or the spectral images have been adjusted to simulate this condition. Typically, this condition is fulfilled by adjusting the images to simulate spatially uniform lighting.

The coefficients in equations (1), (2), and (3) are calculated from some other parameters having to do with relationships between light and image levels:

αₗ=aₗ/Wₗ, (7)

βₗ=bₗ/Wₗ, (8)

γₗ=cₗ/Wₗ. (9)

Substituting these relations in equations (1), (2), (3) yields this variation in the equations for estimating XYZ color coordinates:

$$\begin{matrix}{X}_{e} ( i , j ) = {a}_{1} \frac{{g}_{1} ( i , j )}{{W}_{1}} + {a}_{2} \frac{{g}_{2} ( i , j )}{{W}_{2}} + … + {a}_{n} \frac{{g}_{n} ( i , j )}{{W}_{n}} , & ( 10 ) \\ {Y}_{e} ( i , j ) = {b}_{1} \frac{{g}_{1} ( i , j )}{{W}_{1}} + {b}_{2} \frac{{g}_{2} ( i , j )}{{W}_{2}} + … + {b}_{n} \frac{{g}_{n} ( i , j )}{{W}_{n}} , & ( 11 ) \\ {Z}_{e} ( i , j ) = {c}_{1} \frac{{g}_{1} ( i , j )}{{W}_{1}} + {c}_{2} \frac{{g}_{2} ( i , j )}{{W}_{2}} + … + {c}_{n} \frac{{g}_{n} ( i , j )}{{W}_{n}} , & ( 12 )\end{matrix}$$

There is a reason for the introduction of the new parameters aₗ, bₗ, cₗ, and Wₗ, which will be come apparent later in the discussion: it allows for a simpler recalibration when illumination power or exposure times change but the spectral distributions of light used to form the images remain constant.

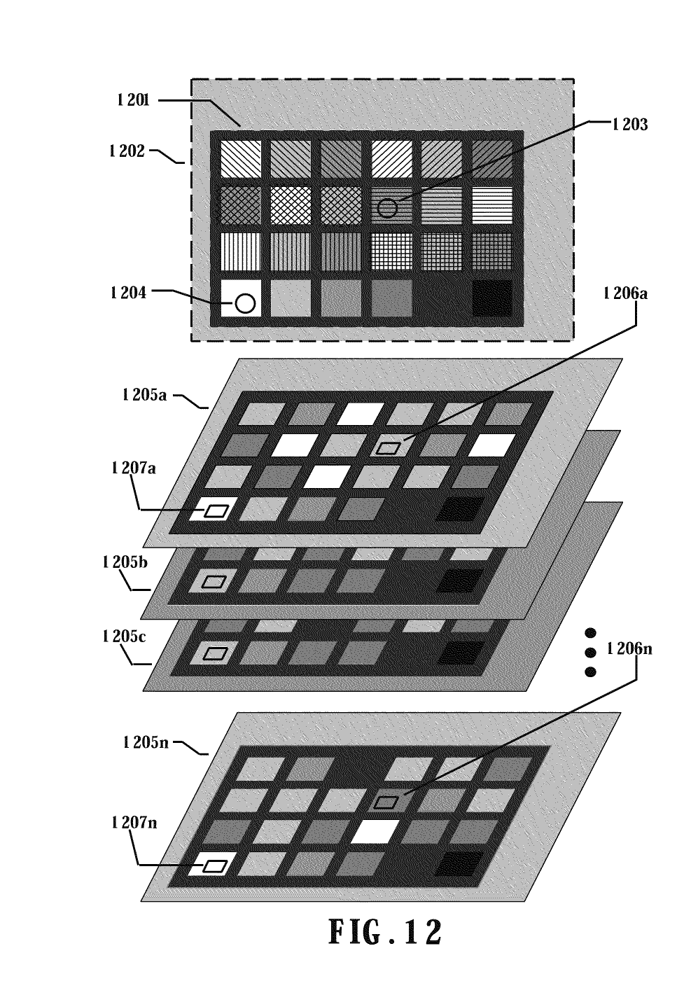

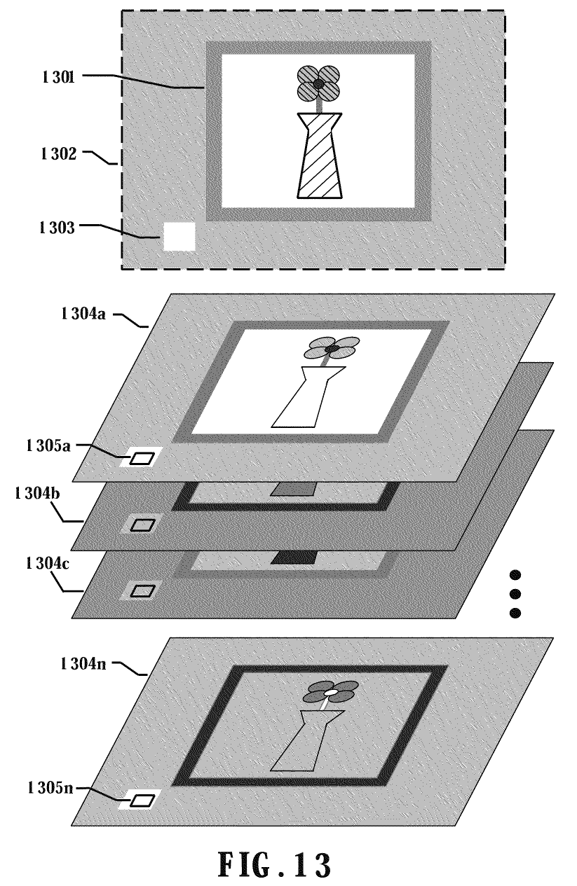

It remains to explain how values for the aₗ, bₗ, cₗ, and Wₗ in equations (10), (11), (12) are found. They are the result of a calibration process based on images of a reference color chart 1201, and, possibly, additional images of a reference white sample 1303, as represented in FIG. 12 and FIG. 13, respectively. Such a chart 1201 will contain a set of color samples, each consisting of a region of the chart's surface that has been covered with a particular coloring agent. It should have been manufactured so as to make the color as uniform as possible over the surface of each sample. The color chart will also contain a reference white sample 1204, and if a separate white sample is also used, it should, ideally have the same response to light as the one on the color chart.

The values of the Wₗ in (10), (11), (12) are derived from a spectral image stack, with component images q₁, q₂ . . . , qₙ, that was obtained by photographing a scene (such as those 1202, 1302 represented in FIG. 12 and FIG. 13) containing a white sample 1204, 1303 equivalent or (identical) to the one on the reference color chart 1202, and, moreover, capturing the component images under essentially the same conditions of lighting and exposure as those used to capture the images g₁, g₂, . . . , gₙ. An image region (a set of image positions) Θ_{w} is selected that lies within the picture of the white patch in each of the component images q₁, q₂ . . . , qₙ. Such a region 1207a, 1207n, 1305a, 1305n is depicted within the first and last component images 1205a, 1205n, 1304a, 1304n of the spectral image stacks represented in FIG. 12 and FIG. 13. Let qₗ(Θ_{w}) denote the average value of qₗ(i, j) over all (i, j) in Θ_{w}. The values of Wₗ in (10), (11), (12) are assigned using some images q₁, q₂ . . . , qₙ and some image region Θ_{w} satisfying the conditions stated above:

Wₗ=qₗ(Θ_{w}), l=1, 2, . . . , n. (13)

Values for the coefficients aₗ, bₗ, cₗ, in equations (10), (11), (12) are determined using two sets of data, as discussed below. One set of data is extracted from a spectral image stack 1205a, 1205b, 1205c, . . . , 1205n with component images h₁, h₂ . . . , hₙ, obtained by imaging a scene 1202, such as that depicted in FIG. 12, that contains a reference color chart 1201. For this data to be relevant to (10), (11), (12), the spectral distributions s₁, s₂, . . . , sₙ of light used to form the images h₁, h₂ . . . , hₙ should be the same or nearly the same, respectively, as those used in capturing the images represented by g₁, g₂ . . . , gₙ in (10), (11), (12). A number, say m, of the color samples on the reference color chart 1201 are selected, including the white sample and assigned identifying indices k=1, 0.2, . . . , m, with the white sample indexed by some integer w among 1, 2, . . . , m. For each color sample, an image region is chosen that lies within the picture of that sample in each of the images, with the region corresponding to sample number k being denoted Ωₖ. Region Ω_{w} 1207a, 1207n, corresponding to the white sample, and region Ω_{c} 1206a, 1206n, corresponding to some typical non-white sample, are indicated within the first and last component images 1205a, 1205n. With hₗ(Ωₖ) denoting the average of hₗ(i, j) over all (i, j) in Ωₖ, the doubly indexed array of values, hₗ(Ωₖ) for k=1, . . . , m, l=1, . . . , n, includes mn values that are to be used in determining values for the aₗ, bₗ, cₗ.

The other set of data, alluded to above, consists of the XYZ coordinates for the colors of each of the m selected samples on the color chart. Using the same indexing as before, let Xₖ, Yₖ, Zₖ be the coordinates for the color of patch number k, as measured by a spectrophotometer. The measurements are taken within some regions 1203, 1204 well within the patches as indicated in FIG. 12. As noted previously the XYZ coordinates will refer to the appearance of colors when the chart is illuminated by light of some designated spectral distributions, as exemplified by CIE Illuminant D50 901 and CIE Illuminant D50 902, plotted in FIG. 9.

Now the aₗ, bₗ, cₗ of equations (10), (11), (12) are determined by solving (or approximately solving) these systems of equations involving the data measured by the procedures described above:

$$\begin{matrix}{a}_{1} \frac{{h}_{1} ( {Ω}_{k} )}{{h}_{1} ( {Ω}_{w} )} + {a}_{2} \frac{{h}_{2} ( {Ω}_{k} )}{{h}_{2} ( {Ω}_{w} )} + … + {a}_{n} \frac{{h}_{n} ( {Ω}_{k} )}{{h}_{n} ( {Ω}_{w} )} = {X}_{k} , \\ k = 1 , 2 , … , m ; & ( 14 ) \\ {b}_{1} \frac{{h}_{1} ( {Ω}_{k} )}{{h}_{1} ( {Ω}_{w} )} + {b}_{2} \frac{{h}_{2} ( {Ω}_{k} )}{{h}_{2} ( {Ω}_{w} )} + … + {b}_{n} \frac{{h}_{n} ( {Ω}_{k} )}{{h}_{n} ( {Ω}_{w} )} = {Y}_{k} , \\ k = 1 , 2 , … , m ; & ( 15 ) \\ {c}_{1} \frac{{h}_{1} ( {Ω}_{k} )}{{h}_{1} ( {Ω}_{w} )} + {c}_{2} \frac{{h}_{2} ( {Ω}_{k} )}{{h}_{2} ( {Ω}_{w} )} + … + {c}_{n} \frac{{h}_{n} ( {Ω}_{k} )}{{h}_{n} ( {Ω}_{w} )} = {Z}_{k} , \\ k = 1 , 2 , … , m . & ( 16 )\end{matrix}$$

When the number of color samples m exceeds the number of components n in the spectral image stack, which is typical in practice, approximate solutions are found, which minimize the differences ε_{X}(k), ε_{Y}(k), ε_{Z}(k) defined by

$$\begin{matrix}{ɛ}_{X} ( k ) = {a}_{1} \frac{{h}_{1} ( {Ω}_{k} )}{{h}_{1} ( {Ω}_{w} )} + {a}_{2} \frac{{h}_{2} ( {Ω}_{k} )}{{h}_{2} ( {Ω}_{w} )} + … + {a}_{n} \frac{{h}_{n} ( {Ω}_{k} )}{{h}_{n} ( {Ω}_{w} )} - {X}_{k} , \\ k = 1 , 2 , … , m ; & ( 17 ) \\ {ɛ}_{Y} ( k ) = {b}_{1} \frac{{h}_{1} ( {Ω}_{k} )}{{h}_{1} ( {Ω}_{w} )} + {b}_{2} \frac{{h}_{2} ( {Ω}_{k} )}{{h}_{2} ( {Ω}_{w} )} + … + {b}_{n} \frac{{h}_{n} ( {Ω}_{k} )}{{h}_{n} ( {Ω}_{w} )} - {Y}_{k} , \\ k = 1 , 2 , … , m ; & ( 18 ) \\ {ɛ}_{Z} ( k ) = {c}_{1} \frac{{h}_{1} ( {Ω}_{k} )}{{h}_{1} ( {Ω}_{w} )} + {c}_{2} \frac{{h}_{2} ( {Ω}_{k} )}{{h}_{2} ( {Ω}_{w} )} + … + {c}_{n} \frac{{h}_{n} ( {Ω}_{k} )}{{h}_{n} ( {Ω}_{w} )} - {Z}_{k} , \\ k = 1 , 2 , … , m . & ( 19 )\end{matrix}$$

More specifically, a well-known method is used to find values of the aₗ, bₗ, cₗ so as to minimize the sums of squares of the differences,

Δ_{X}=[ε_{X}(1)]²+[ε_{X}(2)]²+ . . . +[ε_{X}(m)]², (20)

Δ_{Y}=[ε_{Y}(1)]²+[ε_{Y}(2)]²+ . . . +[ε_{Y}(m)]², (21)

Δ_{Z}=[ε_{Z}(1)]²+[ε_{Z}(2)]²+ . . . +[ε_{Z}(m)]². (22)

The introduction of some matrix notation will facilitate a more detailed exposition. Let H be the m-by-n matrix whose element in row k and column l is hₗ(Ωₖ)/hₗ(Ω_{w}), and let x, y, z be the m-dimensional column vectors whose kth components are Xₖ, Yₖ, Zₖ respectively:

$$H = [ \begin{matrix}\frac{{h}_{1} ( {Ω}_{1} )}{{h}_{1} ( {Ω}_{w} )} & \frac{{h}_{2} ( {Ω}_{1} )}{{h}_{2} ( {Ω}_{w} )} & … & \frac{{h}_{n} ( {Ω}_{1} )}{{h}_{n} ( {Ω}_{w} )} \\ \frac{{h}_{1} ( {Ω}_{2} )}{{h}_{1} ( {Ω}_{w} )} & \frac{{h}_{2} ( {Ω}_{2} )}{{h}_{2} ( {Ω}_{w} )} & … & \frac{{h}_{n} ( {Ω}_{2} )}{{h}_{n} ( {Ω}_{w} )} \\ … & & & \\ \frac{{h}_{1} ( {Ω}_{m} )}{{h}_{1} ( {Ω}_{w} )} & \frac{{h}_{2} ( {Ω}_{m} )}{{h}_{2} ( {Ω}_{w} )} & … & \frac{{h}_{n} ( {Ω}_{m} )}{{h}_{n} ( {Ω}_{w} )}\end{matrix} ] , \\ x = [ \begin{matrix}{X}_{1} \\ {X}_{2} \\ … \\ {X}_{m}\end{matrix} ] , y = [ \begin{matrix}{Y}_{1} \\ {Y}_{2} \\ … \\ {Y}_{m}\end{matrix} ] , z = [ \begin{matrix}{Z}_{1} \\ {Z}_{2} \\ … \\ {Z}_{m}\end{matrix} ] . \qquad ( 23 )$$

The singular value decomposition of linear algebra theory can be used to compute the Moore-Penrose pseudo-inverse of H, the pseudo-inverse being denoted H⁺. Then the choice of n-dimensional column vectors a, b, c which minimize the Euclidean lengths of the m-dimensional column vectors Ha−x, Hb−y, and Hc−z, respectively are determined as a=H⁺x, b=H⁺y, and c=H+z. Now the coefficients aₗ, bₗ, cₗ of equations (10), (11), (12), whose values were to minimize Δ_{X}, Δ_{Y}, Δ_{Z} as defined in equations (17) through (22), can be set equal to the coordinates of a, b, and c; that is,

$$[ \begin{matrix}{a}_{1} \\ {a}_{2} \\ … \\ {a}_{m}\end{matrix} ] = {H}^{+} [ \begin{matrix}{X}_{1} \\ {X}_{2} \\ … \\ {X}_{m}\end{matrix} ] , [ \begin{matrix}{b}_{1} \\ {b}_{2} \\ … \\ {b}_{m}\end{matrix} ] = {H}^{+} [ \begin{matrix}{Y}_{1} \\ {Y}_{2} \\ … \\ {Y}_{m}\end{matrix} ] , [ \begin{matrix}{c}_{1} \\ {c}_{2} \\ … \\ {c}_{m}\end{matrix} ] = {H}^{+} [ \begin{matrix}{Z}_{1} \\ {Z}_{2} \\ … \\ {Z}_{m}\end{matrix} ] . \qquad ( 24 )$$

That the Δ_{X}, Δ_{Y}, Δ_{Z} of equations (20), (21), (22) are thus minimized, can be seen since the minimized Euclidean lengths ∥Ha−x∥, ∥Hb−y∥, and ∥Hc−z∥ are given by

∥Ha−x∥=\sqrt{[ε_{X}(1)]²+[ε_{X}(2)]²+ . . . +[ε_{X}(m)]²}=\sqrt{Δ_{X}}, (25)

∥Hb−y∥=\sqrt{[ε_{Y}(1)]²+[ε_{Y}(2)]²+ . . . +[ε_{Y}(m)]²}=\sqrt{Δ_{Y}}, (26)

∥Hc−z∥=\sqrt{[ε_{Y}(1)]²+[ε_{Z}(2)]²+ . . . +[ε_{Z}(m)]²}=\sqrt{Δ_{Z}}. (27)

These equations, (25), (26), (27) follow from the definitions of the Euclidean length of a vector and from equations (17) through (24).

It should be noted that the proportional relationships among the quotients gₗ(i, j)/Wₗ in equations (10), (11), (12) depend only upon the spectral distributions s₁, s₂, . . . , sₙ of the light used to record, respectively, the images g₁, g₂, . . . , gₙ, and the images q₁, q₂, . . . , qₙ determining the Wₗ (see equation (13)), provided that the two sequences of images were formed under essentially identical conditions of positioning and powering of light sources and exposure times used in capturing the images. Thus the coefficients aₗ, bₗ, cₗ only have to be calibrated once for a given sequence of spectral distributions, while the values Wₗ need to be measured whenever the aforementioned conditions change.

Since the eye is most sensitive to errors in color reproduction if they occur in white or near-white colors, it useful to solve the equation systems (14), (15), (16) in such a way that the equations corresponding to the white sample are solved exactly. For the equation systems (14), such a solution is obtained by using the equation

$${a}_{1} \frac{{h}_{1} ( {Ω}_{w} )}{{h}_{1} ( {Ω}_{w} )} + {a}_{2} \frac{{h}_{2} ( {Ω}_{w} )}{{h}_{2} ( {Ω}_{w} )} + … + {a}_{n} \frac{{h}_{n} ( {Ω}_{w} )}{{h}_{n} ( {Ω}_{w} )} = {X}_{w} , \qquad ( 28 )$$

to express one of the unknowns, say aₙ, in terms of the others, thereby replacing the system in (14) with one having m−1 equations in which aₙ is missing, which system is then solved in the approximate sense. A similar process is applied to the equations systems (15) and (16).

More generally, it could be useful to assign priorities to the accuracy of reproducing the color of various patches on a chart. This is done by choosing a sequence of non-negative numbers dₖ whose ordering by size corresponds to the priorities (larger values for higher priority). Then there will be an approximate solution to the equation system (14), for example, which minimizes the weighted sum of squared errors

d₁²[ε_{X}(1)]²+d₂²[ε_{X}(2)]²+ . . . +dₘ²[ε_{X}(m)]²,

with ε_{X}(k) as defined as in equation (17). In terms of a matrix form of the system, Ha=x, this amounts to solving the matrix equation DHa=Dx approximately, where D is an m-by-m matrix whose diagonal elements are the dₖ and whose other elements are zero.

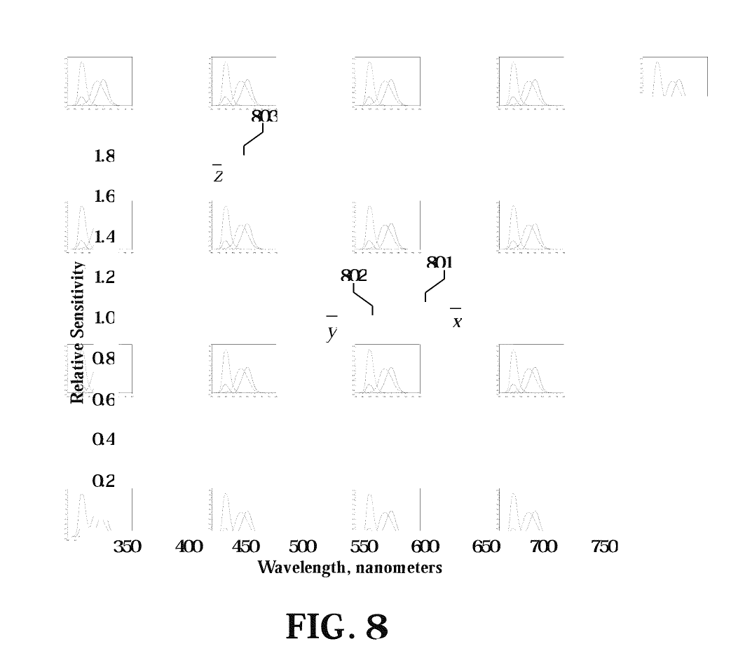

The accuracy in estimating the color of a scene from the information in a spectral image stack, using equations (1) through (6) and the subsequently discussed calibration procedures used to assign values to the coefficients αₖ, βₖ, γₖ in equations (1), (2), (3), depends upon the choice of the spectral distributions s₁, s₂, . . . , sₙ of the light used to record the component spectral images g₁, g₂, . . . , gₙ. While empirical choices such as the emission spectra 701, 702, 703, 704, 705 of some light-emitting diodes, as plotted in FIG. 7, have given good results, considerations based in theoretical color science suggest that accuracy depends upon a particular relationship between the spectral distributions of the light and the CIE sensitivity functions x̅, y̅, z̅ 801, 802, 803 plotted in FIG. 8. More specifically, the ideal conditions for achieving color accuracy are described by

$$\begin{matrix}{α}_{1} {s}_{1} ( γ ) + {α}_{2} {s}_{2} ( λ ) + … + {α}_{n} {s}_{n} ( λ ) \approx \overline{x} ( λ ) \frac{P ( λ )}{E ( λ )} , & ( 29 ) \\ {β}_{1} {s}_{1} ( γ ) + {β}_{2} {s}_{2} ( λ ) + … + {β}_{n} {s}_{n} ( λ ) \approx \overline{y} ( λ ) \frac{P ( λ )}{E ( λ )} , & ( 30 ) \\ {γ}_{1} {s}_{1} ( γ ) + {γ}_{2} {s}_{2} ( λ ) + … + {γ}_{n} {s}_{n} ( λ ) \approx \overline{z} ( λ ) \frac{P ( λ )}{E ( λ )} , & ( 31 )\end{matrix}$$

where P is the spectral distribution of the illuminant on the scene that determines its color appearance, (examples in FIG. 8) E is a function describing the efficiency of the image detector as a function of light wavelength, and the approximations are to hold for wavelengths 2 in the visible range of the electromagnetic spectrum.

Although actual equality in expressions (29), (30), (31) cannot be expected, modifications of the spectra s₁ through choice of light emitters, and possibly through filtration of their light, will allow improvements in the approximations. When a sequence of light sources is found that allows sufficiently accurate approximations using non-negative coefficients αₖ, βₖ, γ, then it becomes useful to devise compound light sources with emission spectra s_{X}, s_{Y}, s_{Z} such that

s_{X}(γ)=α₁s₁(γ)+α₂s₂(λ)+ . . . +αₙsₙ(λ), (32)

s_{Y}(γ)=β₁s₁(γ)+β₂s₂(λ)+ . . . +βₙsₙ(λ), (33)

s_{Z}(γ)=γ₁s₁(γ)+γ₂s₂(λ)+ . . . +γₙsₙ(λ). (34)

If light sources with emission spectra t₁=s_{X}, t₂=s_{Y}, and t₃=s_{Z} are used to record component images g₁, g₂, g₃ of a spectral image stack, then equations (1), (2), (3), for estimating color coordinates take the simple form:

Xₑ(i,j)=g₁(i,j), (35)

Yₑ(i,j)=g₂(i,j), (36)

Zₑ(i,j)=g₃(i,j). (37)

The chief advantage of this scheme for color reproduction would be a reduction of the time needed for image capture.

A compound light source with emission spectrum s_{X} will be created by placing n component light sources with emission spectra s₁, s₁, . . . , sₙ in close proximity to each other relative to their distances from the scene to be illuminated. When their distances from each other are small enough compared to their distance from the scene, these component sources will project light onto the scene with spatial distributions that are practically identical. Then equation (32) will be satisfied or nearly satisfied by powering the component sources simultaneously (or nearly simultaneously), with the relative powers of their emitted light adjusted to have the same proportional relationships as the coefficients α₁, α₂, . . . , αₙ. Compound light sources with emission spectra equal to s_{Y} and s_{Z} will be created by analogous procedures.

In variations on the aforementioned scheme, it would be the wavelength distribution of light energy accumulated over time at the focal plane of the image detector, instead an instantaneous light emission spectrum, that would be shaped. Thus, instead of just individually varying the light power of the various sources, one could also make adjustments in duration of the power, possibly in pulses.

### Fluorescence Accounting Description

We have demonstrated that very accurate color images may be derived from multiple images captured by a monochrome image sensor under different colored illuminants if the scene reflects light and does not source light. Capturing a color image of a scene that contains light sources requires a means of color separation between the scene and the sensor (or a sensor that inherently separates color).

In the case that the scene contains a light source, it is practical to combine one or more color filters with a multi-spectral light source. At first glance, this may seem redundant and impractical, but there are cases where it is practical and indeed, highly advantageous.

For scenes in which light sources constitutes a significant percentage of the light recorded at important locations in the captured images of the scenes, it may be more practical to illuminate with white light and separate all colors using filters rather than using multi-spectral lights. However, for scenes in which the light energy of light sources is small compared to the light energy of reflected (or transmitted, such as in the case that the scene may be translucent) it may still be practical, and indeed, advantageous, to capture the image with multi-spectral lights in combination with colored filters.

There is a particular source of light which is common in many scenes: fluorescence. In scenes which are normally viewed under broadband white light, the fluorescent light emitted from the scene is almost always very small compared to the amount of incident light reflected from the scene. Because the ratio of emitted light to reflected light is very small, the emitted light will contribute only very small color errors in the color image of the scene. Indeed, for most scenes, the amount of fluorescence is so small that its contribution to the recorded color is negligible.

In the case that the scene fluorescence is not negligible, it is possible and practical, by using color filters in conjunction with multi-spectral illuminants, to account for the fluorescence and derive accurate color images which are corrected for the fluorescence. Using filters in combination with multi-spectral illuminants offers the advantage that the fluorescence can be quantified, something which cannot be done using a single broadband white light illuminant together with color filters between the scene and the sensor. Useful information is provided which distinguishes between reflected and emitted light.

Fluorescence is emitted when a fluorophore is excited. Fluorescence excited by UV light can often dominate a scene if only UV light illuminates the scene. But when the UV is in the same proportion as it is in, say sunlight, the fluorescence is usually very small compared to the reflected light. For some scenes, such as artwork, effort is expended to specifically exclude UV from the illuminant due to UV's damaging effects, so the only visible fluorescence is that which is excited by visible light. Since the fluorescence wavelength is always longer than the excitation wavelength, and since the shortest visible wavelength is deep blue (violet), most fluorescence excited by visible light will not be blue. Fluorescence that is nearly the color of the exciter will be very low in energy because most of the energy in the exciter will be reflected; furthermore, it will not be distinguished from the exciter by the human eye, so it contributes to essentially no color error.

Because the amount of fluorescence is small compared to the amount of reflected light, and because most of the fluorescing light is well separated from the excitation light, fairly broadband filters can be used to distinguish the fluorescence from the exciter, characterize the color and intensity of the fluorescence, and adjust the image data such that the fluorescence contributes negligible error to the color image.

There are 2 contributions of fluorescence color error in a color reproductions system comprising multi-spectral lights and a monochrome sensor with no color separation means between the scene and the sensor:
1. Fluorescence at the emission wavelength is erroneously recorded as light at the excitation wavelength.
2. Fluorescence is not recorded at its emission wavelength.
   Thus, the fluorescence is recorded as if it were in a spectral band in which it does not lie, and it is missing from a spectral band in which it does lie; fluorescence is recorded as if it were a shorter wavelength than it actually is.

It is possible to prevent the fluorescence from being recorded where it should not be by capturing with the excitation illuminant though a filter of the same color. E.G., the blue light image can be captured through a blue filter. This approach has several disadvantages:
a. An optical element is inserted into the optical path when capturing an image which contributes substantially to the rendered color image.
b. The filter must be changed when capturing under different colored illuminants, so the optical path changes between captures of images which contribute substantially to the rendered color image.
c. The amount of fluorescence is unknown.

These limitations can be overcome by capturing one or more additional images through one or more color filters, while illuminating with light at a shorter wavelength than the pass band of the filter, then applying corrections derived from the additionally captured images. For example, an image can be captured as usual under the blue light with no blue filter, then an additional image can be captured under the blue light with a red filter. The red filtered image captured under blue light represents a fluorescence color error, and a correction can be derived from this image to correct the unfiltered images captured under blue and red illuminants.

One or more images could be captured though one or more filters which exclude the excitation illuminant. For example, an image could be captured through a red filter, a yellow filter, and a green filter under blue illuminant. These captured images can represent the fluorescence color error more precisely.

We can for example perform the following steps:
a. Turn on one or a plurality of the of the colored illuminants, such plurality combined such that the energies of scene-exposing light from each of the illuminants in the plurality of illuminants are in specific ratios relative to one another
b. Position a filter into the optical path between the scene and the sensor
c. Capture an image of the object scene
d. Turn on a different illuminant or a plurality of illuminants in different scene-exposing energy ratios. Position a different filter into the optical path between the scene and the sensor.
e. Capture another image of the object scene
f. Repeat steps d and e fore each different illuminant/filter combination.

By capturing one or more correction images, the fluorescence can be properly accounted for to whatever additional accuracy is required. Since these correction images generally have very low brightness compared to the images captured without filters, they will have very little deleterious effect on the rendered color image should the filter-captured image be degraded by filter deficiencies or mis-registration due to filter changes and changes in optical path length. Furthermore, because broad band filters are sufficient, gel filters can be effectively employed so as to minimize the optical path differences between exposures.

While a single capture through a single red or yellow filter under a blue illuminant can account for most of the fluorescence likely to be found in a wide range of scenes, some further refinements are possible.

For example, images could be captured both through red, yellow, and green filters, using both blue and cyan excitation illuminants. Separate excitation exposures under blue and cyan could be done, or by turning on both blue and cyan lights at the same time in brightness proportional as they would occur in a standard illuminant (say D50), the fluorescence error image could be captured under both illuminants simultaneously.

Here is an Example Showing a Method to Correct for Fluorescence Wherein Better Color Accuracy is Obtained with Each Successive Correction:
Capture with royal blue light B₀
Capture with cyan light C₀
Capture with green light G₀
Capture with amber light A₀
Capture with red light R₀

### Calculate First Color Image Using B₀, C₀, G₀, A₀, R₀

Capture with blue light and red filter B_{R}

### Calculate:

B₀′=B₀−(B_{R}*(Red filter factor))

R₀′=R₀+(B_{R}*(Red filter factor))

### Calculate Second Improved Color Image Using B₀′ C₀, G₀, A₀, R₀′

Capture with cyan light and red filter C_{R}

### Calculate:

C₀′=C₀′−(C_{R}*(Red filter factor))

R₀″=R₀′+(C_{R}*(Red filter factor))

### Calculate Third Improved Color Image Using B₀′ C₀′, G₀, A₀, R₀″

Capture with Green light and Red filter G_{R}

### Calculate:

G₀′=G₀−(G_{R}*(Red filter factor))

R₀″′=R₀″+(G_{R}*(Red filter factor))

Calculate Fourth Improved Color Image Using B₀′ C₀′, G₀′, A₀, R₀″′

What is claimed is:

1. A multi-spectral image capture system comprising:
(a) an imaging device including an array of sensors for detecting light;
(b) a light source for sequentially producing light in different colors;
(c) a light director for directing light produced by said light source onto, into, or through a scene;
(d) a light director for directing light reflected from, transmitted through, or emitted from the scene onto the array of sensors;
(e) a memory storing images captured by the array of sensors;
(f) a memory storing calibration data associated with the sensor;
(g) a memory storing calibration data associated with the light source;
(h) a memory storing calibration data derived from some of said captured images, said data representing light characteristics as detected by the array of sensors; and,
(i) an adjusting device for adjusting the light signals detected by the array of sensors based on characteristics of the light as detected by the array of sensors and represented by the set of calibration data stored in the memory;

2. The image capture system of claim 1, wherein the memory is coupled to the light source;

3. The image capture system of claim 1, wherein the memory is coupled to the array of sensors;

4. Claim 2, together with an adjustment device for adjusting the light source 5 claim 3, together with an adjustment device for adjusting the array of sensors;

6. The image capture system of claim 1, together with a memory for storing calibration data representing non-uniformities of the lights;

7. The image capture system of claim 6, together with an adjusting device for adjusting the light signal detected by the array of sensor based on non-uniformities of the light;

8. The image capture system of claim 1, wherein the imaging device also includes an aperture;

9. The image capture system of claim 8, wherein the aperture is adjustable;

10. The image capture system of claim 9, wherein the aperture is coupled to the memory;

11. The image capture system of claim 9, together with an adjusting device whereby said aperture is adjusted;

12. The image capture system of claim 1, wherein the imaging device also includes a shutter;

13. The image capture system of claim 12, wherein the shutter is coupled to the memory;

14. The image capture system of claim 12, wherein said shutter is adjustable;

15. The image capture system of claim 12, together with an adjusting device whereby said shutter is adjusted;

16. The image capture system of claim 1, wherein the imaging device is a digital camera;

17. The image capture system of claim 1, wherein the imaging device is a digital scanner.

18. The image capture system of claim 1, wherein the array of sensors is a monochromatic array;

19. The image capture system of claim 1, wherein the array of sensors is a 1 dimensional array;

20. The image capture system of claim 1, wherein the array of sensors is a 2 dimensional array;

21. The image capture system of claim 1, wherein the array of sensors is formed by charge coupled devices (“CCDs”);

22. The image capture system of claim 1, wherein the array of sensors is formed by complementary metal oxide semiconductor imaging devices (“CMOSID's”);

23. The image capture system of claim 1, wherein the first light director comprises a light reflector;

24. The image capture system of claim 1, wherein the second light director comprises a lens;

25. The image capture system of claim 1, wherein the light source comprises a plurality light sources;

26. The image capture system of claim 25, wherein the plurality of light sources comprises a plurality of different bands of spectral energy;

27. The image capture system of claim 25, wherein the plurality of light sources comprises a plurality of sources of the same spectral energy band;

28. The image capture system of claim 1, wherein the light source comprises an array of solid state lights (SSLs);

29. The Image capture system of claim 28, wherein the SSLs produce light in different wavelength bands;

30. The image capture system of claim 1, wherein the adjusting device is furthermore coupled to the array of SSLs for selectively turning on and off the SSLs;

31. The image capture system of claim 1, wherein the adjusting device is coupled to the array of SSLs for selectively adjusting the light intensity output of the SSLs;

32. The image capture system of claim 30, wherein the SSLs are selectively turned on and off such that selectable SSLs are turned on at selectable times and for selectable durations;

33. The image capture system of claim 31, wherein the SSLs are selectively turned on and off such that selectable SSLs are turned on at selectable times and at selectable intensity levels;

34. The image capture system of claim 30, wherein the SSLs are selectively turned on at selectable times for selectable durations and at selectable intensity levels;

35. A method of image capture of a scene, comprising:
a. sequentially directing light in different colors onto, into, or through a scene;
b. collecting the spectral energy reflected from, emitted from, or transmitted through the scene by exposing an image sensor formed of a plurality of pixels for each of the different colors of light;
c. detecting the amount of the collected spectral energy at each pixel across the plurality of pixels in the image sensor for each of the different exposures;
d. Saving to a memory the detected amounts for each of the different exposures as an image;
e. Adjusting the saved images based on calibration data saved in a memory; and
f. Deriving a color image from the saved images, said derivation incorporating calibration data saved in a memory;

36. The method of claim 35, wherein the calibration data used to adjust the saved images is derived from captured images;

37. The method of claim 36, wherein the captured images include a calibration target of known spectral reflectance, emission, or transmission;

38. The method of claim 37, wherein the calibration target comprises a surface of uniform reflectance, transmission, or emission;

39. The method of claim 37, wherein the target encompasses the scene;

40. The method of claim 37 wherein the images of the calibration target are captured under the equivalent lighting conditions as are the images of the scene being adjusted by the calibration data;

41. The method of claim 35, wherein the calibration data used to combine the captured images into a color image is derived from captured images;

42. The method of claim 41, wherein the captured images include a calibration target of known spectral reflectance, emission, or transmission;

43. The method of 42, wherein the calibration target comprises an array of different known spectral reflectance, emissive, or transmissive properties;

45. The method of image capture of claim 35, wherein the spectral energy reflected from, emitted from, or transmitted through the scene surfaces is collected in a separate image formed of a plurality of pixels for each different illuminant light color;

46. The method of image capture of claim 35, wherein the illuminant spectral energy in different wavelength bands is produced by an array of light emitting sources;

47. The method image capture of claim 45, wherein different emitting sources of the array of light emitting sources produce light in different wavelength bands;

48. The method of image capture of claim 47, wherein different emitting sources are selectively turned on and off such that selectable emitting sources are turned on at selectable times and for selectable durations.

49. The method of image capture of claim 47, wherein different emitting sources are selectively turned on and off such that selectable emitting sources are turned on at selectable times and at selectable intensity levels;

50. The method of image capture of claim 47, wherein different emitting sources are selectively turned on at selectable times for selectable durations and at selectable intensity levels;

51. The method image capture of claim 47, including selectively controlling the array of light emitting sources such that when light emitting sources, in particular spectral bands; are emitting light, all light emitting sources that emit light in unselected spectral bands are not emitting light;

52. The system of claim 1 wherein the irregularities in the spectral energy as detected by the array of sensors comprise non-uniform light distribution;

53. The system of claim 1, wherein the captured image is adjusted further by interpolating to correct for pixels labeled as bad;

54. The method of claim 35, wherein irregularities in the collected spectral energy across the plurality of pixels comprise non-uniform light distribution;

55. The method of claim 35, wherein the image formed by the plurality of pixels is adjusted further by interpolating to correct for pixels labeled as bad;

56. A method for deriving a color image from a spectral image stack by means of a transformation that sends each vector of spectral image levels to a vector of color coordinates, wherein the transformation can be calibrated to send any one designated vector of spectral image levels to any one designated vector of color coordinates while simultaneously satisfying a best-fit condition regarding a list of other calibrating conditions on the action of the transformation;

57. The method of claim 56, wherein the transformation is a linear transform;

58. The method of claim 56. wherein the best-fit condition is the minimization of the sum of the squares of the list of errors corresponding to the list of other calibrating conditions.

59. The method of claim 56, wherein the transformation is linear and the best-fit condition is the minimization of the sum of the squares of the list of errors corresponding to the list of other calibrating conditions;

60. The method of claim 56, wherein a spectral image stack, obtained by imaging a target containing color samples is used, and the designated vector of spectral image levels is derived from image levels in the spectral image stack at positions corresponding to a designated color sample and the designated vector of color coordinates refers to the known color of the designated color sample;

61. The method of claim 60, wherein the color of the designated color sample is white or a shade of white;

62. The method of claim 56, wherein the method of claim 35 is used to capture the component images of the spectral image stack;

63. The method of claim 62, wherein the spectral image stack has been adjusted to correct for light sources in the scene;

64. The system of claim 1, wherein each sensor in the array of sensors is located at a pixel spatial location and each sensor measures a pixel; and wherein adjusting the light signal detected by the array of sensors comprises, for each light color:
a. determining a difference by subtracting from each pixel measurement a measurement taken by the corresponding sensor when exposed for an equivalent duration to no light; and;
b. adjusting for spatial non-uniformity in the light at the scene surface as detected by the array of sensors by:
multiplying each pixel's said difference by a factor derived from calibration data stored in a memory, the factor corresponding to the pixel spatial location of the measured pixel;

65. The system of claim 64, wherein the said factor is the ratio of a normalized spectral reflectance of a calibration surface at that pixel spatial location over a measurement of the calibration surface by the sensor located at that pixel spatial location;

66. The method of claim 35, wherein the image formed by a plurality of pixels is adjusted, for each light color, by:
a. adjusting for detected changes in the spectral energy by:
determining a difference by subtracting from each pixel measurement a measurement taken by the corresponding sensor when exposed for an equivalent duration to no light; and
b. adjusting for spatial non-uniformity in the light at the scene surface as detected by the array of sensors by:
multiplying each pixel's said difference by a factor derived from calibration data stored in a memory, the factor corresponding to the pixel spatial location of the measured pixel;

67. The method of claim 66, wherein the said factor is the ratio of a normalized spectral reflectance of a calibration surface at that pixel spatial location over a measurement of the calibration surface by the sensor located at that pixel spatial location;

68. The method of claim 35, wherein the power and/or duration of each of a sequence of lights of various spectral distributions are adjusted so as to control the spectral distribution of the total emitted energy of the lights used in exposing an image sensor, and control said spectral distribution so as to give it a designated form;

69. The method of claim 68 wherein the designated form of the spectral distribution of the total emitted energy of the lights has a shape substantially resembling that of any one of the CIE XYZ sensitivity functions, either those devised in 1931 for the 2-degree standard observer, or those devised in 1965 for the 10-degree standard observer;

70. The method of claim 68 wherein the designated form of the spectral distribution of the total emitted energy of the lights has a shape substantially resembling that of any one of the CIE XYZ sensitivity functions mentioned in claim 69, multiplied by the spectral distribution of any one of the CIE standard illuminants, and divided by the light-to-signal efficiency of the of the image detector as a function of wavelength;

71. The system of claim 1, wherein the power and/or duration of each of a sequence of lights of various spectral distributions are adjustable so as to control the spectral distribution of the total emitted energy of the lights used in exposing the image sensor, such that said spectral distribution may be given a designated form;

72. The method of claim 71 wherein the designated form of the spectral distribution of the total emitted energy of the lights has a shape substantially resembling that of any one of the CIE XYZ sensitivity functions, either those devised in 1931 for the 2-degree standard observer, or those devised in 1965 for the 10-degree standard observer;

73. The system of claim 1, together with a color filter or a plurality of color filters selectably placed between the object scene and the array of sensors;

74. The system of claim 73, together with an apparatus which places the filter or the plurality of filters into and removes the filter or plurality of filters from the optical path between the scene and the sensor in synchronization with changing the color of the illuminant;

75. The system of claim 73, together with an apparatus to change the filter properties of an adjustable color filter, in synchronization with changing the color of the illuminants;

76. The method of claim 35 wherein a color filter or a plurality of color filters are selectably placed between the scene and the image sensor in synchronization with changing the color of the illuminant;

77. The method of claim 76 wherein images are captured through the color filter or plurality of color filters and said images are used to derive corrections to colors of a derived color image that account for light sources in the scene;

78. The method of claim 35 wherein the adjustments of claim 35 are informed by data derived from images captured by the method of claim 77.
